(19) United States
(12) Patent Application Publication
(10) Pub. No.: US 2009/0068984 A1
(43) Pub. Date: Mar. 12, 2009

(54) METHOD, APPARATUS, AND SYSTEM FOR CONTROLLING MOBILE DEVICE USE

(76) Inventor: R. Alan Burnett, Bellevue, WA (US)

Correspondence Address: LAW OFFICE OF R. ALAN BURNETT, 4108 131ST AVE. SE, BELLEVUE, WA, 98006, US

(21) Appl. No.: 11/851,256

(22) Filed: Sep. 6, 2007

(51) Int. Cl. H04M 11/00

(52) U.S. Cl. 455/408

(57) ABSTRACT

Method, apparatus and system for controlling usage of mobile devices. Supervisor users, such as parents and managers, are enabled to define usage-level based rule sets that are employed to limit mobile device use by targeted users, such as children and employees. The rule sets may be employed to control access to outbound and incoming calls, as well as text messages, data transfers, and paid content. Warning trip points may also be set to provide warnings to users when corresponding usage levels have been reached during a given billing cycle. Various mechanism are disclosed for enabling specification of rule set parameters, including via a mobile device, a computer application, and a Web portal. Runtime operations may be performed via the mobile device, via service provider infrastructure, or via a combination of the two to control mobile device use in view of applicable rule sets and current service plan operating modes.

### FIELD OF THE INVENTION

The field of invention relates generally to mobile devices and, more specifically but not exclusively relates to methods, apparatus, and systems for controlling mobile device usage to reduce service overage charges.

### BACKGROUND INFORMATION

Use of mobile devices, such as cellular (a.k.a. “mobile”) phones, PDA's, pocket PC's, Blackberry devices, etc. has become increasingly popular over the past decade. This has been fueled, in part, by widely-available access to low-cost cellular phones. Typically, the retail price of the cellular phone is reduced in exchange for a service contract of one or more years. Many times, the price is reduced to the point that the phone is “free.” This almost sounds too good to be true—there must be a catch.

Under a common scenario, cellular phone retailers are reimbursed by service providers to cover the price reduction of such “free” and similarly reduced-price offerings in exchange for signing up users for service contracts. The service provider has gained several advantages once a user has signed up for service. These include receiving a minimum use fee (typically monthly) for whatever service package the user has selected. Under most contracts, the user must pay the use fee throughout the contract period, or pay a substantial penalty for canceling the contract. Another advantage gained by the service provider concerns the belief that in most areas cell phone numbers are particular to one service provider and are not transferable to another service provider, or that transferring the number is a big hassle. As a result, users usually continue service with the same service provider in order to keep the same cellular number. Although phones may now be unlocked to enable transfer to a new service, most users either are unaware of this capability or simply don't want to bother changing providers.

Oftentimes, the cost of the service multiplied by the number of months under a minimum service contract is less than or proximate to the savings in the cost of the cellular phone. That doesn't sound like much of a deal for the service providers. In fact, the service providers don't make out too well with subscribers who only pay the minimum usage fees. However, the service providers do substantially better for subscribers who pay much larger bills as a result of additional usage fees, commonly referred to as “overages.” The usage fees that add up the quickest are roaming fees, extra minute fees, and text messaging fees.

For example, suppose there is a service provider that offers a basic plan that includes 300 “anytime” minutes and 1000 ‘night and weekend’ minutes a month for only $30/month. For each minute exceeding the 300 or 1000 minutes (as applicable), a charge of $0.45/minute is billed. Such a service plan is very tempting for parents with teenagers, under the thought that the teenager will have access to a cellular phone for emergency purposes or similar “important” purposes.

However, practical experience has taught many a parent that purchasing a basic service plan for a teenager may not be the wisest decision. While the parent may have decided to purchase the phone for one reason, the teenager has different ideas. A call here to Lauren, a received call from Sally there, and another from Mary, etc., and those 300 anytime minutes easily turn into 1000, 2000, or even more used minutes. Suddenly that $30/month bill turns into a $200+ per month bill.

Another revenue stream for the wireless providers is text or instant messaging services. Typically, a service plan may include a certain number of free messages, with a nominal charge for each message sent or received thereafter. Instant messages are an ideal revenue source for service providers, since a charge may be incurred for each message, and a single “conversation” may involve 10's or even 100's of text messages being exchanged. Moreover, charges are incurred for both incoming and outgoing messages. At typical fees of $0.10 per extra text message, text message services have become cash cows for many providers.

Yet other revenue streams relate to data services. These typically include charges for Web access (i.e., the related amount of data transfers) and e-mail, and may additionally include one-time billing charges for various types of downloaded content including ringtones, music, games, and streaming video.

This excess billing situation can become even worse when roaming is involved. Roaming charges are typically the highest type of per-minute charge from a service provider, usually in the range of $0.65-$0.95 per minute. Oftentimes, the user isn't even aware they are roaming, since most cell phones only provide a small icon or text indicia indicating that the user is in roaming territory. Excess roaming charges can be particularly problematic for business travelers and people who travel abroad. Amazingly, “nationwide” coverage doesn't include Canada—this poses a problem for geographically-challenged users.

What is clearly needed is a convenient means for limiting excess minute usage, roaming charges, text messages, data transfers, etc., while at the same time enabling users such as teenagers and employees to have access to cellular phones for important purposes, such as emergencies.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like components or operations throughout the various views unless otherwise specified:

FIG. 1a is a schematic diagram of a first set of exemplary user interface screens by which a user can enter access control parameter data via a cellular phone including setting limits and warnings for airtime minutes and text messages;

FIG. 1b is a schematic diagram of a second set of exemplary user interface screens by which a user can enter access control parameter data via a cellular phone including setting limits and warnings for data transfers and ringtone/music/game charges;

FIG. 2 is a schematic diagram illustrating a set of user interface screens by which a user can assign access levels to selected contacts via a cellular phone;

FIG. 3 is a schematic diagram illustrating a set of user interface screens by which a user can assign operation rules for corresponding operational mode conditions determined by used minutes;

FIG. 4 is a is a schematic diagram illustrating a set of user interface screens by which a user can assign operation rules for corresponding operational mode conditions corresponding to roaming operations;

FIG. 5 is a representation of an exemplary web page by which a user can enter various access control parameters generally pertaining to analogous parameters entered in FIGS. 1 and 2;

FIG. 6 is a representation of an exemplary web page by which a user can enter various access control level assignment data for contacts and allowed operation rules;

FIG. 7 is a schematic diagram illustrating an embodiment in which user data entered via the web pages of FIGS. 5 and 6 are downloaded to a cellular phone;

FIG. 8 is a schematic diagram illustrating an exemplary user interface screen corresponding to an application program that enables control access parameters and assignment data to be entered via a computer and downloaded to a cellular phone;

FIG. 9a is a flowchart illustrating operations and logic performed by firmware and/or software running on a cellular phone in response to an outgoing call attempt made by a user of a cellular phone in accordance with an embodiment of the invention;

FIG. 9b is a flowchart illustrating operations and logic performed by firmware and/or software running on a cellular phone in response to an incoming call connection request made by a user of a cellular phone in accordance with an embodiment of the invention;

FIG. 9c is a flowchart illustrating operations and logic performed by firmware and/or software running on a cellular phone in response to an attempt to send or receive a text message via a cellular phone in accordance with an embodiment of the invention;

FIG. 9d is a flowchart illustrating operations and logic performed by firmware and/or software running on a cellular phone in response to an attempt to access data transfer service via a cellular phone in accordance with an embodiment of the invention;

FIG. 9e is a flowchart illustrating operations and logic performed by firmware and/or software running on a cellular phone in response to an attempt to access a fee-based service via a cellular phone in accordance with an embodiment of the invention;

FIG. 10 is a schematic diagram of an exemplary service provider infrastructure for implementing control access operations in accordance with an embodiment of the invention;

FIG. 11 is a data model corresponding to a portion of a database schema that is employed in the database of FIG. 10;

FIG. 12a is a flowchart illustrating operations and logic performed by software running on computer servers operated by a service provider in response to an outgoing call attempt made by a user of a cellular phone in accordance with an embodiment of the invention;

FIG. 12b is a flowchart illustrating operations and logic performed by firmware running on computer servers operated by a service provider in response to an incoming call connection request made by a user of a cellular phone in accordance with an embodiment of the invention;

FIG. 12c is a flowchart illustrating operations and logic performed by software running on computer servers operated by a service provider in response to an attempt by a user of a cellular phone to send a text message or to deliver a text message to a cellular phone in accordance with an embodiment of the invention;

FIG. 12d is a flowchart illustrating operations and logic performed by software running on computer servers operated by a service provider in response to an attempt by a user of a cellular phone to access data transfer service in accordance with an embodiment of the invention;

FIG. 12e is a flowchart illustrating operations and logic performed by software running on computer servers operated by a service provider in response to an attempt by a user of a cellular phone to access a fee-based service in accordance with an embodiment of the invention;

FIG. 13 is a schematic diagram illustrating various user access modes and corresponding contact access modes and allowed operation rule logic;

FIG. 14 is a schematic diagram illustrating an overview of a unlicensed mobile access (UMA) infrastructure for a UTRAN implementation;

FIG. 15a is a flowchart illustrating operations and logic performed in conjunction with attempting an outgoing call using a dual-mode handset that supports licensed mobile network and unlicensed wireless network access in accordance with one embodiment of the invention;

FIG. 15b is a flowchart illustrating operations and logic performed in conjunction with receiving a request to connect an incoming call using a dual-mode handset that supports licensed mobile network and unlicensed wireless network access in accordance with one embodiment of the invention;

FIG. 16 is a flowchart illustrating operations and logic performed in conjunction with performing a handover from an unlicensed wireless network to a licensed mobile network using a dual-mode handset that supports licensed mobile network and unlicensed wireless network access in accordance with one embodiment of the invention;

FIGS. 17a and 17b are block schematic diagrams illustrating exemplary software architectures the may be employed to implement aspects of the embodiments disclosed herein;

FIG. 18 is a block schematic diagram illustrating an implementation of a agent-based software architecture hosted by a Symbian operation system;

FIG. 19 is a schematic diagram illustrating a hardware and firmware architecture corresponding to a cellular phone via which user access control in accordance with an embodiment of the invention is implemented; and

FIG. 20 is a schematic diagram of an exemplary computer server that may be used for implementing software aspects of embodiments of the invention pertaining to the service provider infrastructure of FIG. 10.

### DETAILED DESCRIPTION OF PREFERRED EMBODIMENTS

Embodiments of methods, apparatus and systems for controlling mobile device access are described herein. In the following description, numerous specific details are set forth to provide a thorough understanding of embodiments of the invention. For example, many of the embodiments are described in the context of their application to cellular phones. Similar techniques may be used for other mobile devices, as well. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

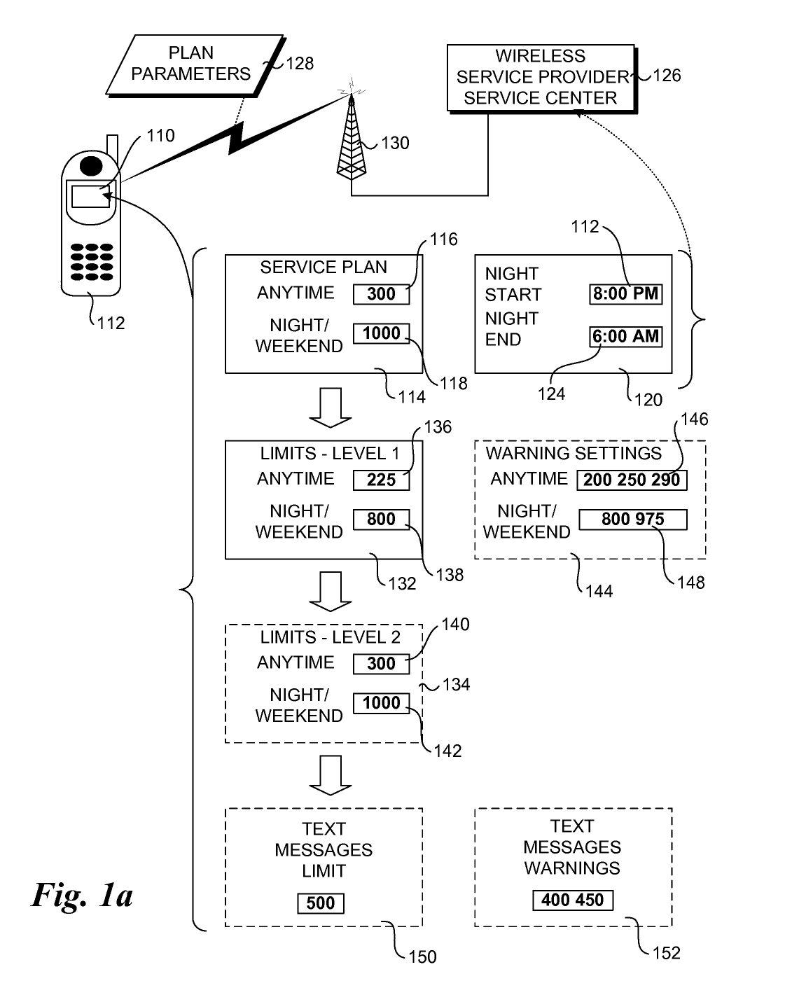

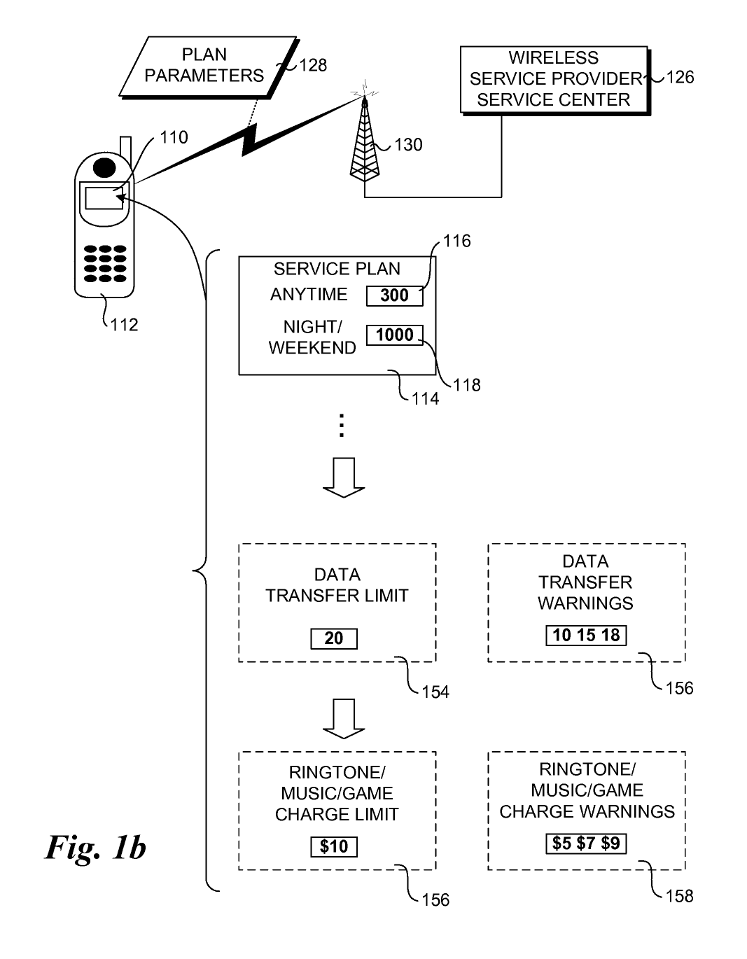

In accordance with aspects of the invention, purchasers of cellular phone services are enabled to selectively control cellular phone access of target users, such as children, business people, and others who may benefit from the teachings disclosed herein. A first exemplary operation for facilitating these capabilities involves defining access rights and settings. As described in further detail below, access rights generally may be defined via a cellular phone, local software application, or via a web-based portal. For example, FIGS. 1a-b and 2-4 depict various exemplary cellular phone user-interface (UI) screens that enable a supervisor user (such as a parent, manager, etc.) to set up access levels for one or more target users.

In most instances, it will be desirable to enable only authorized users to set up access rights. This prevents the target users from changing access rights for their own benefit, defeating the purpose of setting up access rights in the first place. Accordingly, in order to set up access rights, an authorization process should be performed, such as entering a username and password. Since any of various well-known authorization techniques may be employed for the embodiments of the invention discussed herein, details of such authorization techniques are omitted for clarity.

Under one embodiment, mobile device usage is controlled relative to service plan parameters. Accordingly, there needs to be some mechanism for enabling a supervisor user to enter or select such service plan parameters. Returning to FIG. 1a, under one embodiment, this information may be entered via one or more user interface (UI) screens that are displayed on a display screen 110 of a cellular phone 112. For example, in a UI screen 114 a user may enter the number of “anytime” minutes in an edit box 116 and the number of “night and weekend” minutes in an edit box 118. (It is noted that for simplicity, the exemplary UI screens shown herein typically employ edit boxes for entering information. In actual practice, hierarchical menu and selection options may be employed, as are similar to those employed by many cellular phones. Accordingly, any commonly-employed user input technique may be used to enable user entry or selection of data.) Generally, the UI screen should reflect the various plan parameters that may exist. For example, some service plans define other use types in addition to “anytime” and “night and weekend” minutes. In some instances, “night and weekend” minutes are “unlimited”; accordingly, UI screen 114 may support corresponding indicia indicating such in addition to the numerical value illustrated in FIG. 1a. In other instances, night and weekend minutes are accounted for separately.

In general, embodiments that control user access via a mobile device (vs. controlling access via service provider infrastructure) will need to provide a means for delineating what type of usage is being used. For instance, in one embodiment the type of usage (anytime or weekend/night minutes, for example) is delineated based on the present time (i.e., during the call) and the time spans defined for each usage type. Such time spans may be defined via a UI screen 120, which enables a user to define the start and end times for “night” usage in respective edit boxes 122 and 124. In accordance with this “night” delineation, the delineations for “anytime” and “weekend” minutes are implied by their names.

In one embodiment, rather than requiring entry of the baseline plan parameters, such information may be downloaded to the mobile device from the plan's service provider, either periodically, or on demand. For example, a service provider operating a service center 126 may send plan parameter data 128 to cellular phone 112 via an antenna 130, which is used to depict a typical cellular service antenna infrastructure employing a plurality of cells, as is well-known in the art.

After the baseline service plan information if entered, the supervisor user will generally begin defining access rights. In one embodiment, this consists of setting usage limits at one or more usage levels. For example, the supervisor user may enter usage levels for two usage levels (1 and 2) via UI screens 132 and 134, respectively. In general, the usage level UI screens should contain information that corresponds to associated plan parameters. For example, if the service plan includes a third usage type (in addition to anytime and night/weekend minutes), the corresponding access level limit UI screens may include input for entering limits for such usage types.

In accordance with the present example, the supervisor user may define an access level 1 anytime minute limit by entering the number of minutes in an edit box 136 (or otherwise selecting the number of limits via another UI entry mechanism, such as a list (not shown)). Similarly, night and weekend minute limits may be entered in an edit box 138.

Typically, at least one set of access level limits will be employed. Optionally, a number of access limits may be employed, whereby different access rights will be applied depending on which access level is current. Accordingly, the supervisor user may define anytime minute and weekend minute limits corresponding to a second access level in edit boxes 140 and 142, respectively.

In addition to setting access level limits, a user may desire to select warning settings. Since warning settings don't affect access rights, in some embodiments these may be accessed by both the supervisor user and the target user, while in other embodiments they are only accessible to supervisor users. In an exemplary UI screen 144, a user is enabled to enter one or more warnings that are to be issued whenever a corresponding number of anytime minutes and/or night and weekend minutes have been used. For illustrative purposes, multiple values are displayed in each of edit boxes 146 and 148. In practice, multiple limits may also be entered via multiple edit boxes or the like.

Many service plans offered today include text or instant messaging (also known as “texting”). Generally, these service plans will include either unlimited text messages or allocate a fixed number of “free” text messages, whereafter a nominal fee is charged for each additional text message (both outgoing and incoming). Mobile-to-mobile text messaging is very popular with teenagers, and is the de facto communication choice for teenagers in Asia.

In accordance with another aspect of the invention, means are provided for limiting text messages. Typically, one or more UI screens, such as UI screen 150, will be used to enable a supervisor user to define text message limits. As before, a single access level may be employed, as well as multiple access levels. The selected text message limit may correspond to the number of free messages, or may be some other value. In one embodiment, the supervisor user may enter a dollar limit in lieu of entering a specific number of messages (not shown), wherein the “functional” limit will correspond to the number of messages required to occur prior to reaching a billing charge corresponding to the dollar limit. As a further option, either the supervisor user or the target user may enter or select warning values corresponding to trigger points at which warning messages are to be provided warning the user X many messages have been used and/or Y number of messages are left before the limit is reached, as exemplified by a UI screen 152.

Data usage has increased dramatically in recent years with improvement in phone Web browsers and increases in mobile-specific Web sites. Accordingly, FIG. 1b shows additional UI screens 154 and 156 for setting limits and warnings for data transfers, such as those incurred for Web usage and e-mail service. For example, UI screen shows a data transfer limit of 20 MB, while UI screen 156 shows warning settings at 10, 15, and 18 MB. As before, various initial settings may be automatically populated based on corresponding current service plan limits and parameters.

Another common charge incurred by mobile phone usage is one-time charges, such as for downloading ringtones, downloading games, purchasing MP3 files, streaming video, accessing pay-for sites, etc. FIG. 1b shows additional exemplary UI screens for 156 and 158 for limiting such one time charges and for providing warnings corresponding to accrued charges per billing cycle.

Once overall access rights are defined, the supervisor user will generally begin defining individual access rights. These access rights pertain to other users that may receive incoming call from or send outgoing calls to the target users. Although a supervisor user might desire to “cut-off” all phone usage once a limit is reached, it will generally be desirable to enable continued use for specific purposes, such as emergencies. Along this line of thinking, it is noted that in one embodiment a set of emergency phone numbers that are always accessible may be programmed into the mobile device. These include 911 by default.

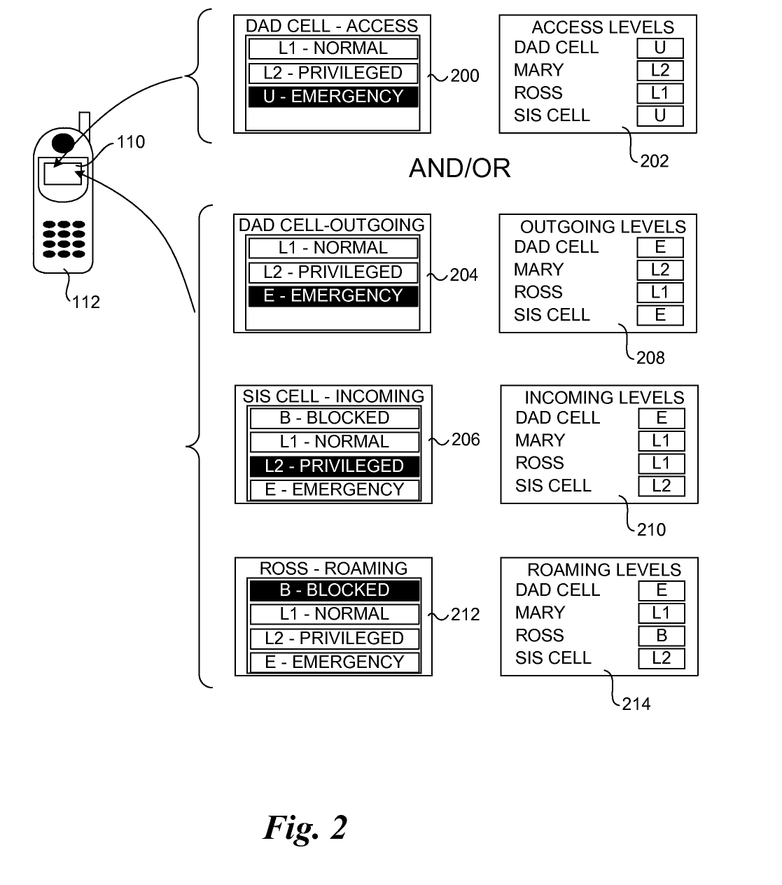

In accordance with one embodiment, a set of individual access rights are defined for one or more “other” users. As shown at the top of FIG. 2, the supervisor user is enabled to define an individual access right to another user having an identity of “DAD CELL” (indicating that corresponds to calls between cellular phone 12 and a cell phone used by a target user's Father). Typically, individual access rights may be employed in connection with entering a new contact, much like assigning a “speed dial” code. Such access rights may also be selected for existing contacts in a similar manner. For instance, once the new contact is entered or an existing contact is selected, the supervisor user may select an access level for the contact via a UI screen 200. In one embodiment the access rights include “BLOCKED,” “NORMAL” (assigned to access level L1), “PRIVILEGED” (assigned to access level L2), and “EMERGENCY.” As their respective names imply, each of the foregoing access rights provides different levels of user access.

Typically, the contacts included in a given list will correspond to people who know the target user. As such, many of these contacts may be assigned an access right of “PRIVILEGED” or “EMERGENCY.” Generally, access rights for non-specified contacts (i.e., people who have phone numbers not contained in the supervisor user-defined list) will be assigned a default access right that is applied at run-time. In some instances, it may be desired to block access with a contact altogether by using the “BLOCKED” access right. In one embodiment, supervisor users are presented with a list of contacts, whereby the supervisor user can quickly select an access right by entering a correspond code adjacent to each contact, such as depicted in a UI screen 202.

In accordance with another embodiment, individual access rights may be assigned for outgoing and incoming calls, as well as for roaming calls. These access rights are entered in a similar manner to that discussed above, except in this instance access rights will be entered or selected for both outgoing and incoming calls, as depicted by UI screens 204 and 206. As shown in UI screens 208 and 210, different access rights for outgoing and incoming calls may be assigned to the same contact.

In addition to outgoing and incoming calls, the supervisor user may select access rights for selected contacts for roaming conditions, as depicted by UI screens 212 and 214. It may also be desired to further delineate roaming access rights by assigning access rights for outgoing and incoming calls while roaming separately (not shown).

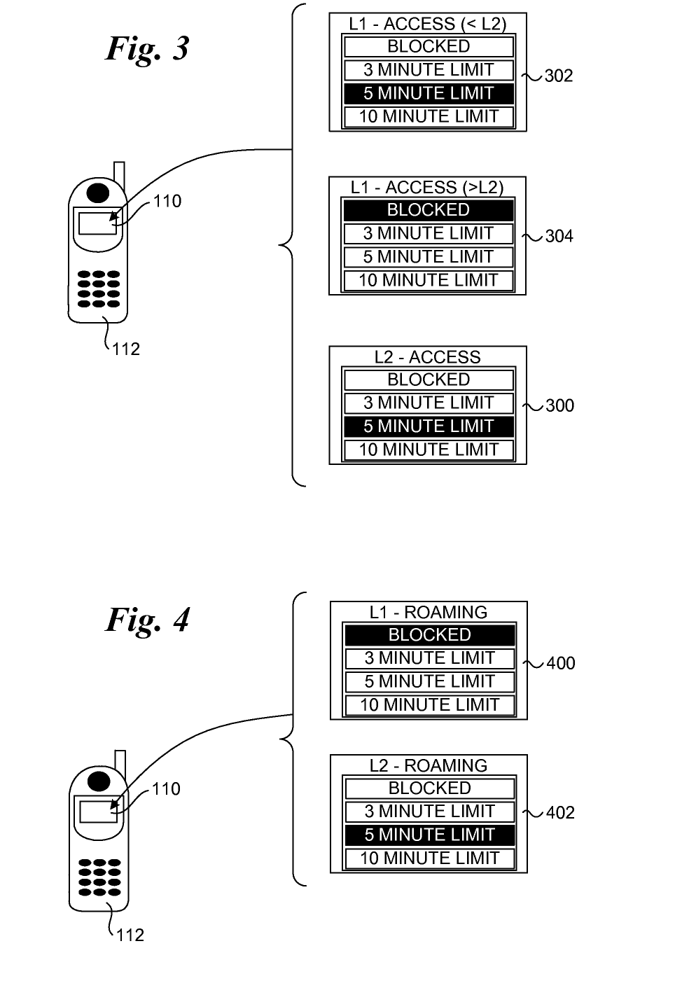

In accordance with another aspect of the invention, access level parameters may be defined such that corresponding accessibility is provided under appropriate circumstances. For example, rather than simply blocking usage when a certain access level occurs (do to prior usage), the supervisor user may select to provide access for a limited amount of time, such as shown in a UI screen 300 in FIG. 3. Access level parameters may also be assigned to the same general access level so as to be applied under different circumstances. For example, a different set of access rights for a given access level (e.g., level 1) may be defined for circumstances corresponding to when the usage access level is simply at the first level (e.g., level 1) and when it moves to a higher level (e.g., level 2), as illustrated by UI screens 302 and a UI screen 304.

As shown in FIG. 4, similar access level parameters may be defining for roaming conditions. For example, in accordance with the “BLOCKED” selection shown in UI screen 400, contacts having an L1 access right will be blocked for both incoming calls from and outgoing calls to when the target user is roaming. In accordance with a UI screen 402, the target user may originate or receive calls of up to five minutes while roaming for contacts assigned an access level of L2. In accordance with call-length limit, a monitor mechanism could be implemented to restrict repeated calls to the same recipient or received from the same sender within a given time period. For example, calls to or from the same number may be limited to one call an hour, five calls a day, etc.

As discussed above, in other embodiments various limit and warning parameters may be entered via a more conventional type of user interface, such as a web page or a software application. Since a typical computer screen has a much higher resolution and display area than a corresponding cellular phone screen, the same limit and warning parameters that were entered above via a large number of cellular phone UI screens may be entered on a much fewer number of web pages/computer application screens.

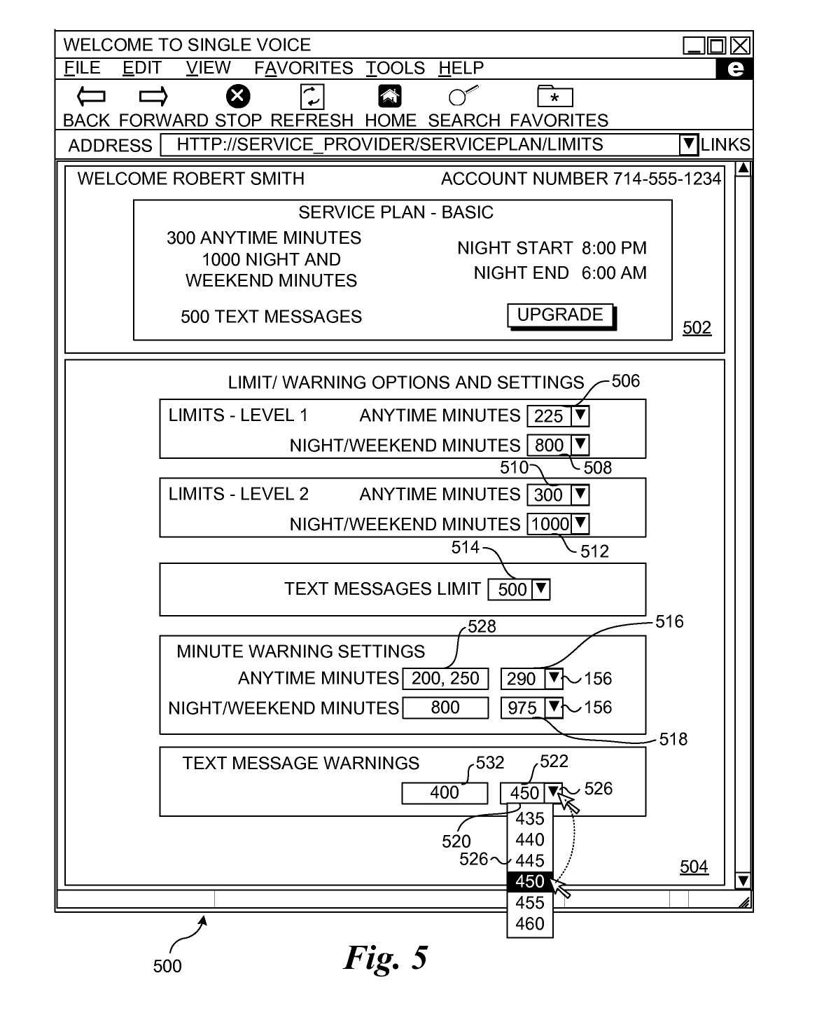

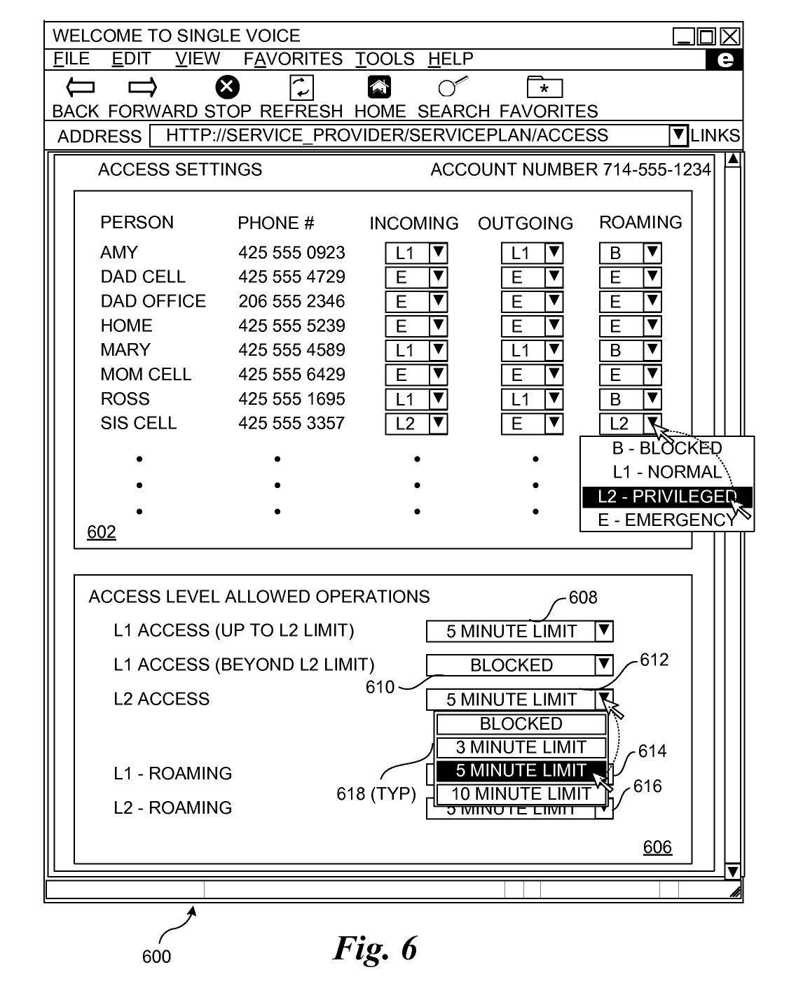

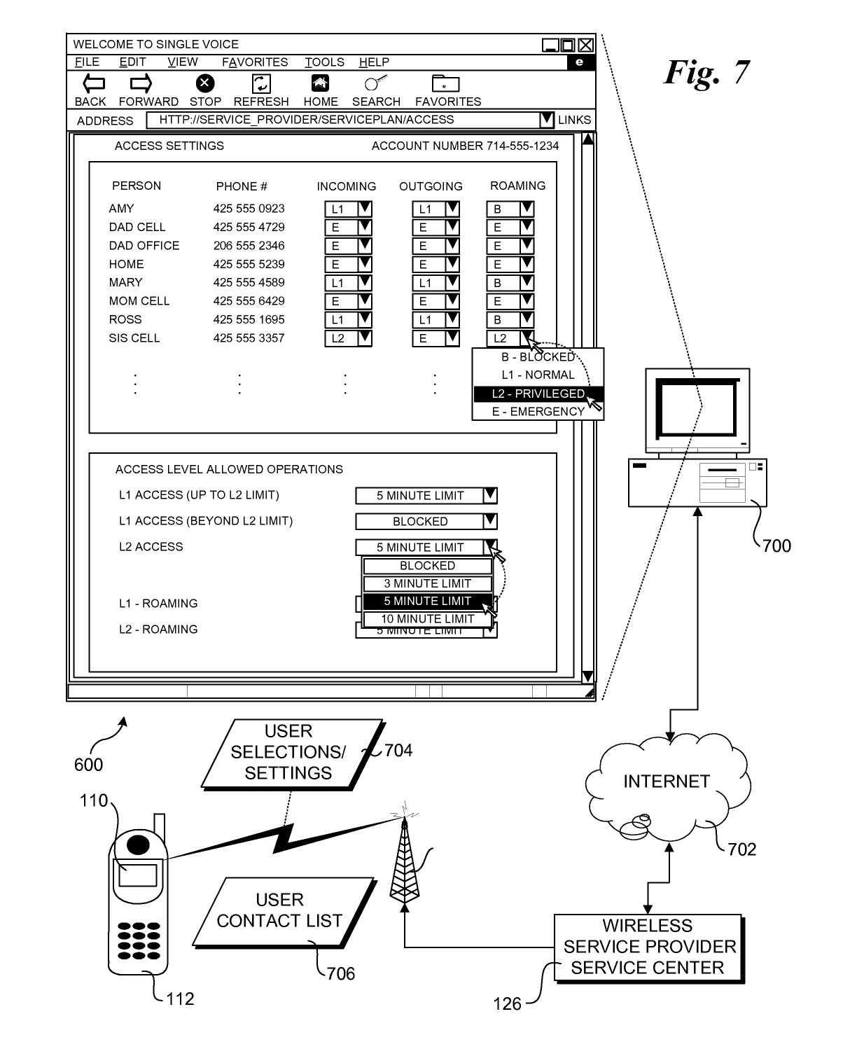

For example, an exemplary web-page UI including pages 500 and 600 are shown in FIGS. 5 and 6. Typically, such web pages will be hosted by a service provider or a third party contracted for hosting web pages for the service provider. Optionally, such web pages may be hosted by a third party software application vendor. Oftentimes, a service provider will already have a web site that enables registered users to access and/or enter various user information. Generally, the user will need to register with the site, and be authenticated each time user enters the site. This protection enables supervisor users to select and enter various limit and warning parameters, while preventing unauthorized users (such as target users or hackers) from accessing the same.

Returning to FIG. 5, web page 500 includes a service plan frame 502 and a limit/warning setup frame 504. Service plan information is displayed in the service plane frame, such as the number of anytime minutes, night and weekend minutes, etc. The registered user is enabled to select/enter various limit and warning parameters via corresponding UI controls in limit/warning setup frame 504. In one embodiment, the UI controls include combination edit box/pulldown (combo) controls 506, 508, 510, 512, 514, 516, 518, and 520. As shown toward the bottom of FIG. 5, the user may either enter a value directly in an edit box 522 part of the control, or select a pulldown control 524 and select a value from a pulldown list 526. In the illustrated embodiment, one or more warning parameter is displayed in an edit or list box displayed adjacent to that warnings text description, including edit/list boxes 528, 530, and 532. In addition to the UI controls and dialogs shown, similar controls and dialogs could be provided for setting limits and warnings for Web data downloads and one-time charges; these are not shown in FIG. 5 for clarity.

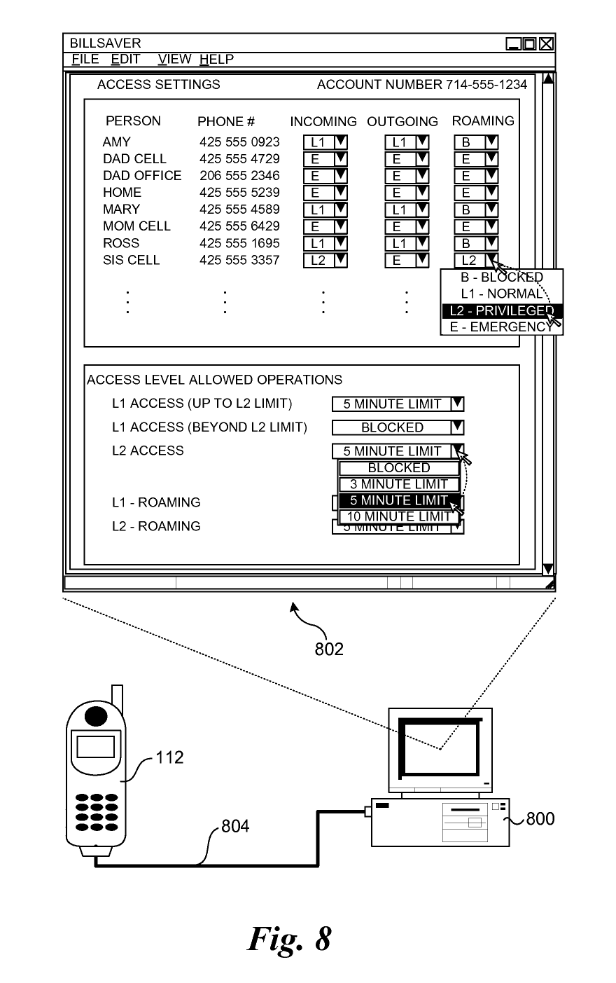

Various access right information may be entered/selected via web page 600, as shown in FIG. 6. In the illustrated embodiment, the registered user is enabled to select access rights for incoming outgoing and roaming calls for various contacts in a user list in a frame 602. This is facilitated, in part, by a plurality of combo controls 604. In one embodiment, information pertaining to each contact and a corresponding phone number for that contact may be entered via the web page. In another embodiment, information 706 pertaining to a contact list stored in a users cellular phone may be “uploaded” to the web site (e.g., via an automatically-generated text message or via a wireless access protocol (WAP) interface or via HTTP, for those cellular devices that are WAP-enabled or are configured to communicate via HTTP, as shown in FIG. 7.

A frame 606 includes various UI controls for enabling entry/selection of access level parameters. These include combo controls 608, 610, 612, 614 and 616 (614 and 616 are partially obscured). Each of these combo controls includes a pulldown list 618 containing a list of options corresponding to that control.

As shown in FIG. 7, the registered user (e.g., a supervisor user) will typically use a computer 700, such as a personal computer, laptop, or handheld computer, to access web pages 500 and 600 via internet 702. At the back end, described in further detail below, the various information entered/selected by the registered user will be stored in a database at service center 126. Once the user information has been entered and saved, corresponding user selections/setting data 704 may be downloaded to cellular phone 112. As mentioned above, in one embodiment a user may “upload” user contact list information 706 to the service center 126, whereupon such information can be used to automatically populate frame 602.

As shown in FIG. 8, UI pages that are similar to web pages 500 and 600 may be rendered by a software application program running on a computer 800 that is used to directly communicate with cellular phone 112. For example, a UI page 802 shown in FIG. 8 corresponds to web page 600 in FIG. 6. Typically, a “feature” connector 804 particular to the model for cellular phone 112 will be used to link the cellular phone in communication with computer 800 (and thus the application program). Such connectors are available for many modern cellular phones, and typically may be connected the computer end via a serial or USB interface. In another option, many mobile devices support Bluetooth connectivity, enabling information to be transferred between a mobile device and another Bluetooth-supported device, such as a laptop.

The various user-defined parameters and settings entered via the exemplary schemes described herein comprise a usage access “rule set”—that is, a set of rules that define access rights in view of current conditions, such as time of day, accrued usage level, etc. The usage access rule set is used during “run-time” operations to control access to various phone usages, such as allowing or preventing incoming and/or outgoing calls, limiting text messaging, data transfers, content downloads, etc.

### Family Plans

In addition to defining usage access rule sets for individual users, it is contemplated that access rule sets may be defined for family plans is a similar manner. For instance, the usage settings for various levels could be based on accrued airtime for a set of family members' mobile devices. In response to specified level trip points, access for selected family member mobile devices could be restricted in a similar manner to that discussed herein for individual users. For example, a supervisor user could define a usage access rule set to limit incoming and outgoing calls to selected recipients/senders (such as parents and other trusted parties) for one or more child users once a corresponding family airtime usage level is accrued for a given billing cycle.

Moreover, parameters to implement such rule sets may be automatically generated or otherwise provided based on the particular family plan for a given family. For example, suppose a family includes Mom, Dad, Sis, Jr., and Princess, and the family service plan includes 700 anytime minutes that are collectively accrued via all of the family members' airtime usage. Automatically-generated parameters could be provided such that once a given usage level is reached (e.g., the plan limit of 700), the children would be restricted from calling or receiving calls from all parties other than family members. Meanwhile, no restrictions would be placed on Mom and Dad's mobile device use. Of course, this could be an initial set of parameters that could be selectively changed by the supervisor user.

### Mobile Device Runtime Operations

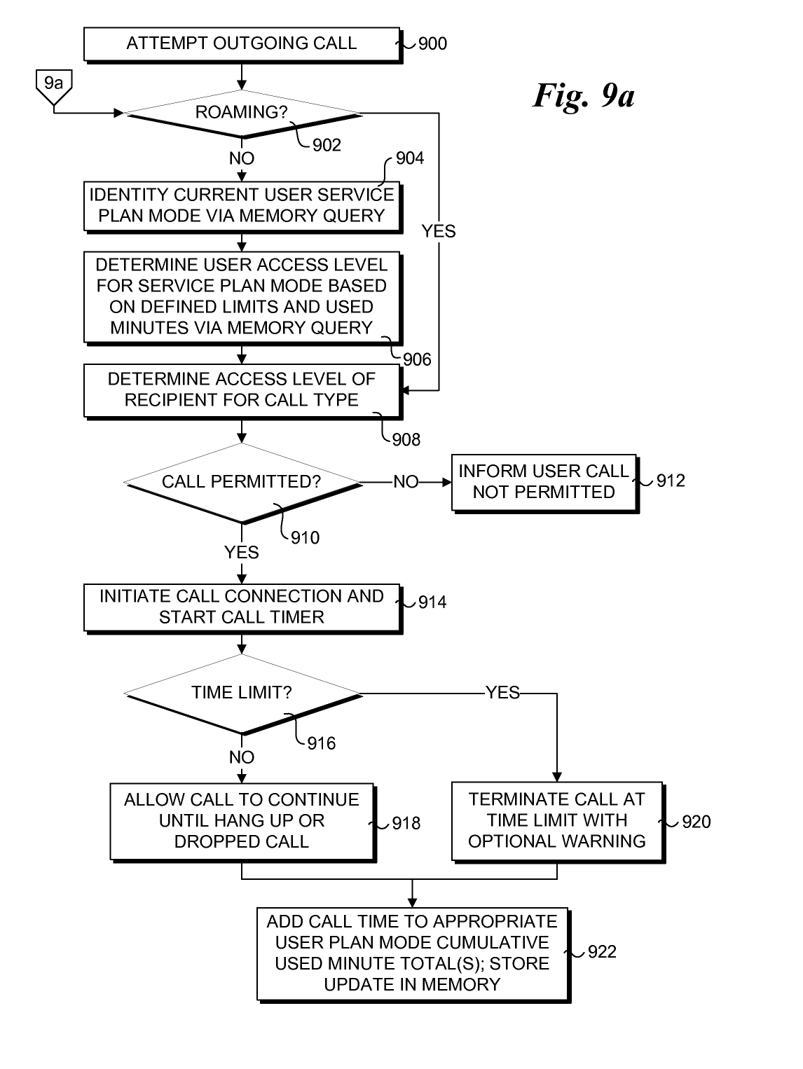

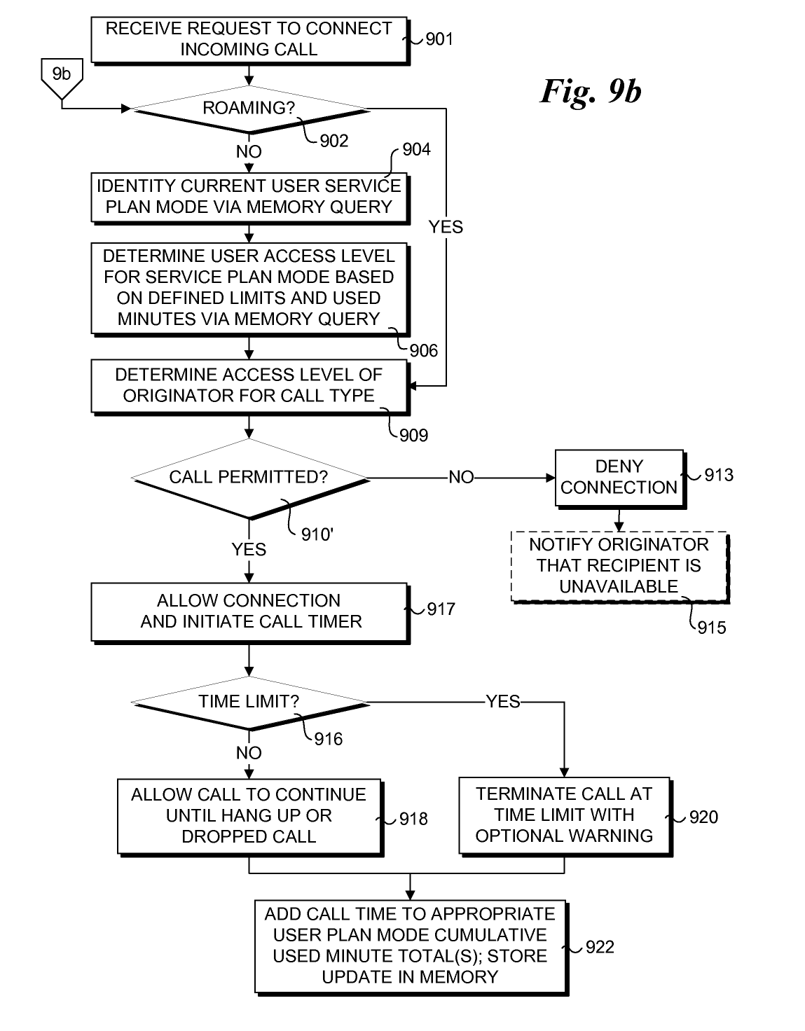

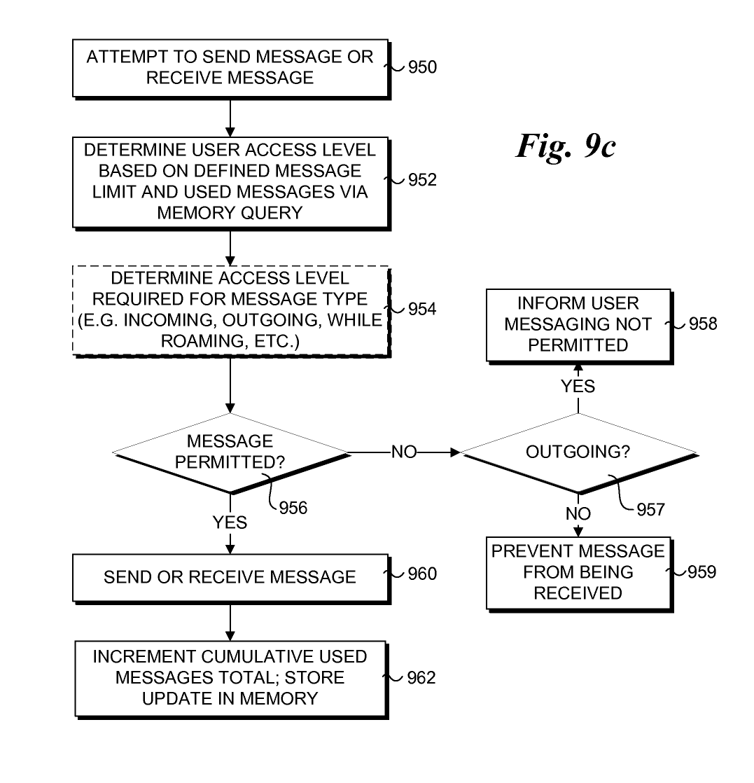

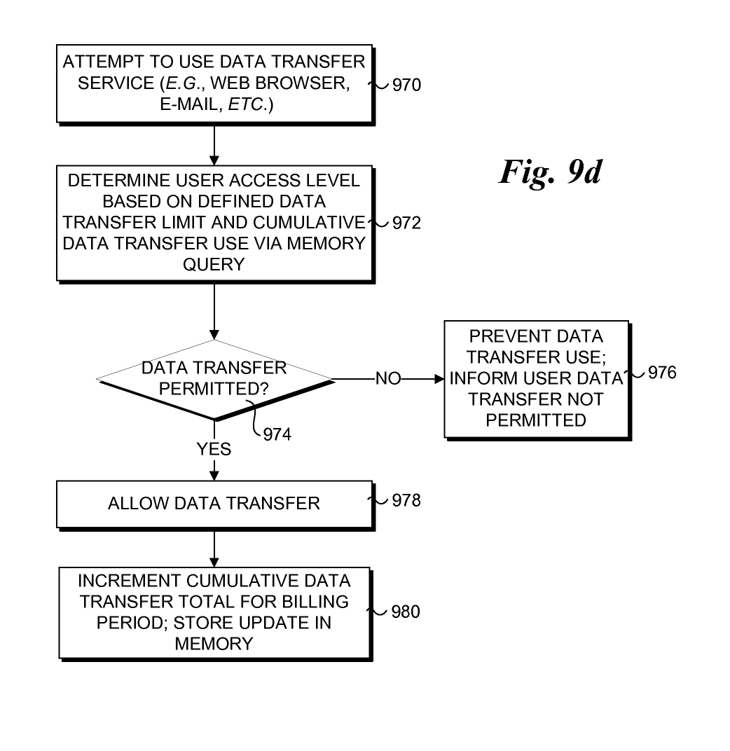

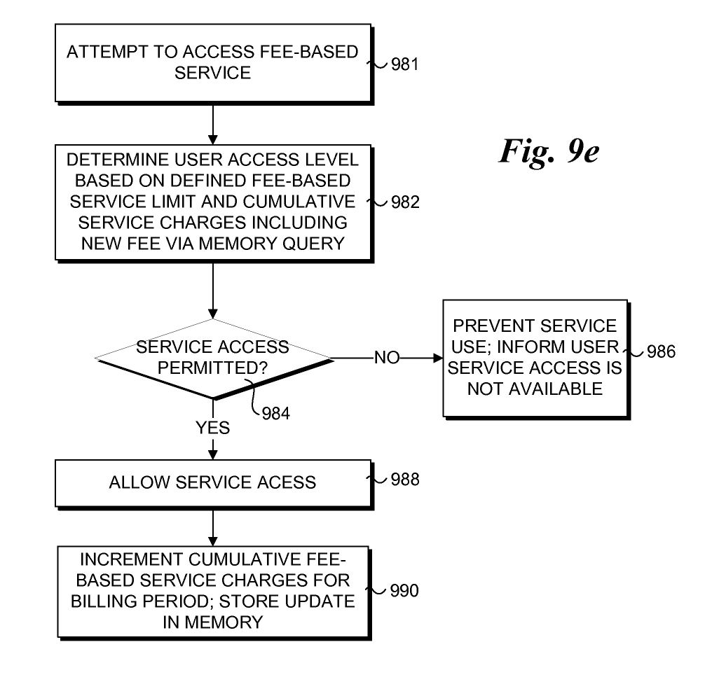

With reference to the flowchart of FIG. 9a, the foregoing user-defined access rule set is employed during mobile device “run-time” operations in connection with an outgoing call in the following manner. First, in a block 900 the target user attempts to make an outgoing call using cellular phone 112 in the normal manner. In a decision block 902 a determination is made to whether the user is roaming. If so, the logic proceeds to a block 908 discussed below. If the user is not roaming, the logic proceeds to a block 904 in which the current plan mode is identified. For example, if the plan modes include anytime and night and weekend modes, a determination of which mode is in effect is made.

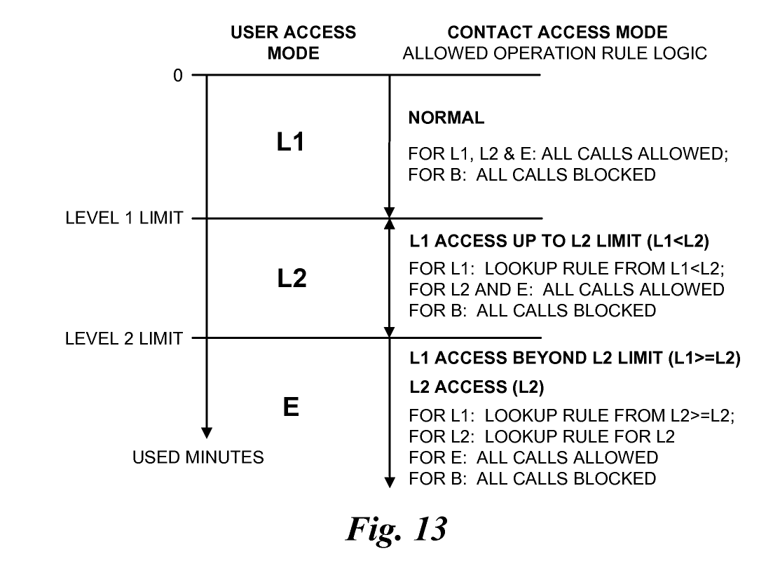

Next, in a block 906 the user access level for the identified plan mode is determined based on the defined limits (performed above) and the currently used minutes for the identified plan mode. For example, in accordance with the foregoing example and the graphic shown in FIG. 13, the user access level will be level 1 (L1) prior to using the number of minutes defined for the Level 1 limit, Level 2 (L2) when the number of used minutes are between the limits defined for Level 1 and Level 2, and emergency (E) one the number of minutes defined for the Level 2 limit have been exceeded. In block 908, the access level of the call recipient for the call type determined. For example, if the call recipient is “MARY,” and the user is not roaming, the recipient access level is L1 (Level 1), as defined above based on the values shown in frame 602 of FIG. 6. If the user is roaming, then the access level for “MARY” is B (Blocked).

After the applicable access level information is obtained, a determination is made in a decision block 910 to whether the call is to be permitted. This will depend on a combination of the user mode access level and the recipient access level. Generally, if the recipient access level is higher than the user mode access level, the call will be permitted. If the recipient access level is lower or equal to the user mode access level, appropriate allowed operation rule logic is employed, as detailed in FIG. 13 and discussed below. In general, under this latter set of circumstances the call will either be denied, or a time limit for the call will be enforced by the applicable rule. If the call is denied, the user will be informed of such in a block 912.

For example, if the current user mode access level is Level 2 (L2) (corresponding to a situation in which either the call plan mode is the “anytime” mode and the number of previously used anytime minutes has exceeded the corresponding Level 1 limit but not the Level 2 limit, or if the call plan mode is “night and weekend” mode and the number of used night and weekend minutes has exceeded the corresponding Level 1 limit but is less than the Level 2 limit) and the recipient access level is L1, the call will be allowed, but limited to 5 minutes in length, as provided by the selection corresponding to UI screen 302 above, in accordance with the L1 access up to L2 Limit (L1<L2) allowed operation rule logic.

If the call is permitted, the next operation is performed in a block 914, wherein the call and a corresponding call timer are initiated. In a block 916 a determination is made to whether a time limit is applicable. For example, if the recipient has an access level of L2 and the current user mode access level is L2, the selection made for UI screen 300 limits the call to 5 minutes. If no time limit is applicable, the logic proceeds to a block 918 in which the call is allowed to continue until a call-ending event, such as one of the call participants hanging up or the call being dropped. If a time limit is applicable, the call is terminated at the call limit time in a block 920. As an option, one or more warnings may be provided during the call to let the user know the call is about to be terminated. In either case, at the end of the call the call time is added to the cumulative total of used minutes for the current plan mode in a block 922. Typically, the cumulative totals for the applicable modes will be automatically reset to zero at the end of a given billing cycle. However, for service plans that provide “Rollover” minutes, the number of rollover minutes may be stored. In general, the billing cycle dates may be entered via a cellular menu option, or entered via a web page or application program and downloaded to the cellular phone (all not shown).

There are multiple schemes for maintaining the current usage levels during a given billing cycle. Under one embodiment, the total usage is maintained via the mobile device itself (i.e., by software/firmware on the device keeping track of usage in a database or data structure or the like). In another scheme, the usage is maintained by the service provider, as is commonly done today. Under a hybrid approach, usage data maintained by the service provider may be provided to the mobile device on a periodic manner (e.g., once a day during a low call-volume period), in response to a user request, or via a push service, wherein the service provider pushes usage data to the mobile device in a periodic manner.

A flowchart illustrating operations and logic performed in response to an incoming call is shown in FIG. 9b, wherein operations corresponding to blocks in FIG. 9b having the same reference number as blocks in FIG. 9a are similar to the operations discussed above for those blocks. The operations begin in a block 901 in which a request to connect an incoming call is received at cellular phone 112. Operations corresponding to decision block 902 and blocks 904 and 906 are performed in a similar manner to that discussed above. In a block 909, the access level of the originator for the call type is determined. For example, suppose an incoming call is received from Amy and the target user is not roaming. In this instance, Amy's access level is L1. If the target user is roaming, then Amy's access level is B(locked).

In a block 910′, a determination is made to whether the call is permitted. This determination is performed in a manner similar to that discussed above for decision block 910, except in this instance the access level to be considers pertains to a call originator rather than a call recipient. If the call is not permitted, the connection is denied in a block 913, and (optionally) the originator is notified that the recipient is unavailable in a block 915. If the call is permitted, the connection is allowed, and the call timer is initiated in a block 917. The rest of the operations in decision block 916 and blocks 918, 920, and 922 are performed in a similar manner to that discussed above with reference to FIG. 9a.

In addition to controlling cellular phone call access, embodiments of the invention may be used to control text messaging access. Generally, service plans will provide a certain number of text messages for free (such as 100, 200, 500, etc., or in some cases unlimited), and will charge a fixed fee per message after the limit has been exceeded. These charges typically apply to both sent and received messages, although the charges for these different events may differ (e.g., $0.10 per sent message, $0.05 for received message). In addition, extra charges may be billed for accessing text messages while roaming.

In accordance with the foregoing exemplary set-up parameters, various UI screens were provided for setting a text message limit. This is not meant to be limiting, as a level-based and individual access level-based access schemes that are similar to the phone call access schemes discussed above may also be employed. Generally, since text messages are not commonly used for emergency situations (the phone would still be available for this) and are normally used for “chatting,” implementing a scheme that blocks all text message use after a limit has been reached will not create a safety problem. However, there may be some situations (e.g., a kidnapping, home intrusion, etc.) under which it will be advantageous to send a text message rather than making a phone call. Accordingly, usage criteria may be set up to enable text message access to selected recipients, such as parents and police. In one embodiment, local police numbers are automatically populated in the mobile device memory and/or maintained by the service provider such that a text message to “Police” will get delivered to a local police and/or emergency facility.

Text message controls may also be used to limit the number of messages that may be sent and/or received on a periodic basis once a usage threshold level is reached. For example, parameters could be entered to form a rule that would restrict texting to 10 messages per day after a threshold limit is reached.

With reference to FIG. 9c, operations and logic performed to control text messaging access begins in a block 950 in which an attempt to send or receive a text message occurs. In a block 952 the user access level is determined based on the defined message limit and used messages via a memory query. As discussed above, there usually will only be one user access level to consider (blocked or unblocked). In cases that a multi-level access scheme is employed, the access level for the message type, such as incoming, outgoing, or while roaming, is determined in a block 954. A determination is then made in a decision block 956 to whether the message is permitted based on the appropriate access level data retrieved in block 952 and optionally block 954.

If the message is not permitted and the message is an outgoing message (i.e., corresponding to an attempt to send a message), the user is informed that the message cannot be sent in accordance with a decision block 957 and a block 958. As another option, the user may be prevented from performing text messaging edit operations (corresponding to creating a new text message to be sent) to begin with if outgoing text messages are blocked. If the message is not permitted and is an incoming message, the message is blocked from being received in a block 959. If the message is permitted, the message is sent or received in a block 960, and the cumulative used message total is incremented and updated in a block 962.

It is noted that in many instances text messages are stored on a service provider server, and the service provider sends a signal to the cellular phone indicating that a new text message is waiting to be retrieved. Under such circumstances in combination with a “blocked” user mode, the user may be either prevented from retrieving a new text message from the server, or the indicia indicating that a new text message is available may be prevented from being displayed on the cellular device (thus effectively blocking access to the message).

FIG. 9d shows a flowchart illustrating operations and logic performed in connection with control of data transfer use. In a block 970, an attempt to use a data transfer service is detected. For example, if a user opens a Web browser or begins to edit an e-mail message such an event is detected. In a block 972, the user access level is determined based on the defined data transfer limit and cumulative data transfer use for the current billing period stored in memory. As depicted by a decision block 974, if the data transfer is not permitted, the logic flows to a block 976 in which data transfer use is prevented and a corresponding message is provided to the user for the mobile device display. If the data transfer is permitted, it is allowed in block 978, and the cumulative data transfer total for the billing period is incremented, with the update stored in memory.

Since some types of data transfer use are ongoing, such as Web browsing, the cumulative data transfer total are updated during a Web browsing session. If the total exceeds the data transfer limit during the session, the session will be forced to close, and a corresponding message will be provided to the user.

Controlling access to paid-services, such as ringtone downloads, music downloads, game downloads, etc., is similar to that used for data transfers. With reference to FIG. 9e, the process begins in a block 981 in which the user attempts to access a fee-based service. In a block 982, the user access level is determined based on the defined fee-based service limit and cumulative service charges for the billing period including the new fee via a memory query. As depicted by a decision block 984, if the service access is permitted, the user is allowed to access the service (e.g., download the ringtone, music, game, etc.) in a block 988, and the cumulative fee-based service charges for the billing period are updated and stored in memory.

### Controlling Access via the Service Provider

In accordance with additional aspects of the invention, access to mobile device use is implemented by the service provider rather than having the device itself perform such functions. This scheme provides the advantage of enabling existing mobile devices to be used without any modifications. It also may be more convenient for most users and provides the service provider with the most flexibility.

During a typical cellular phone call or text message operation, information pertaining to the call or message is routed through a service provider service center. Generally, service providers employ one or more service centers for their service operations, with the number of service centers dependent on the particular geographical deployment of wireless infrastructure for the service provider's cellular network. In many cases, a central service center is employed, along with multiple satellite service centers. Typically, the central service center will provide connection functionality that enables users having different service providers to communicate. Both central and satellite service centers also may provide various switching and routing operations.

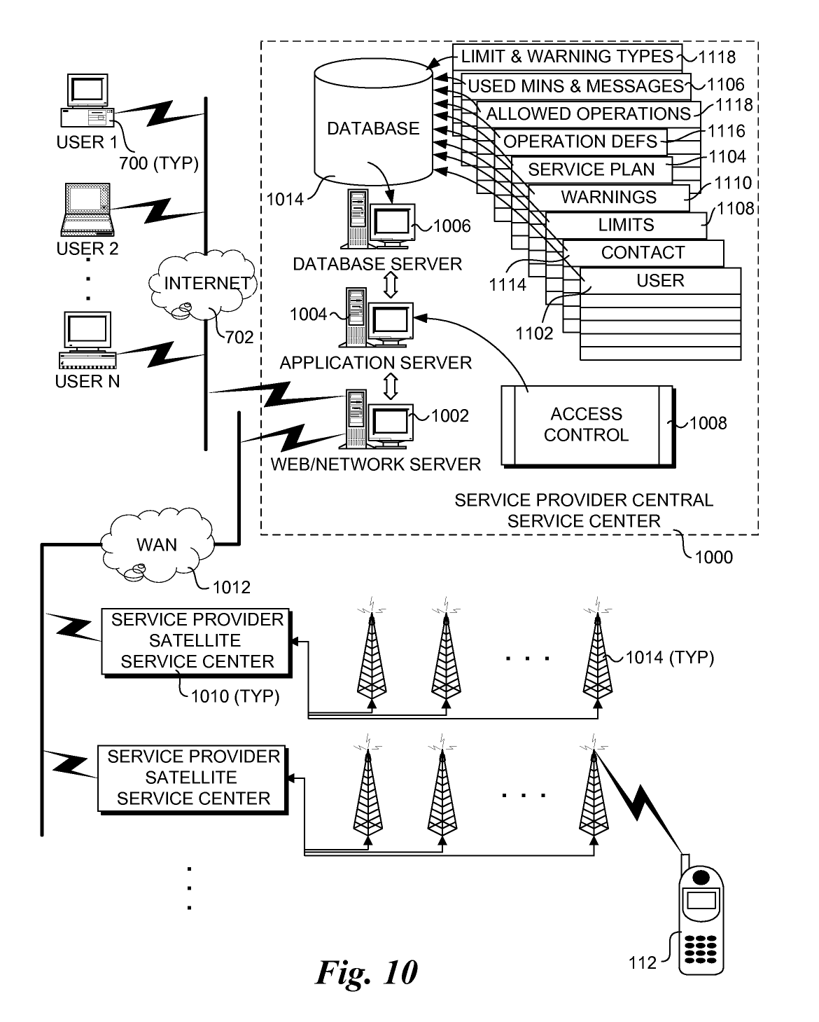

An exemplary cellular device access control scheme in accordance with an embodiment of the invention that may be implemented using a typical service provider infrastructure is shown in FIG. 10. The scheme support two primary types of operations: 1) user setup, in accordance the web-based setup scheme discussed above with reference to FIGS. 5-7; and 2) run time operations corresponding to user activities.

At the heart of the implementation infrastructure is a service provider central service center 1000. In addition to various computer and switching equipment for handling typical wireless communication activities (not shown for clarity), central service center 1000 includes deployment of a three-tiered software architecture including a web and network server tier 1002, and application server tier 1004, and a database server tier 1006. Such n-tier architectures are commonly used for various service center operations, and are well-known in the art.

The web/network server tier will typically employ communications software running on one or more web/network servers. The same machine(s) may be used for hosting both web and network services, or separate machines may be employed for these respective tasks. Web server services provided by this tier enable various users of computers 700 to access a web site hosted by the service provider that contains web pages served by the web server(s) to enable users to select/enter various parameters for controlling cellular device access in the manner discussed above with reference to FIGS. 5-7.

Typically, one or more servers at the application server tier 1004 will be running application software that performs “middleware” services for handing interaction between the web servers and one or more database servers operating in database server tier 1004 (also known as the “backend” tier). The servers in the various tiers are linked together via using conventional network techniques (such as via LANs and/or WANs). As discussed in further detail below, the application server tier also executes access control software 1008 that controls user access of cellular devices during ongoing run-time operations.

The network servers in web/network server tier 1002 are used to enable communication between central service center 1000 and satellite service centers 1010 via WAN 1012. Each of the satellite service centers provides cellular networking services for a plurality of cells, represented by cellular antennas 1014. These types of cellular infrastructure networking techniques are well-known in the art.

Computer servers corresponding to database server tier 1006 are used to host a database 1014. Typically, the database will comprise a relational database management system (RDBMS) database hosted by a corresponding RDBMS server product running on one or more computer servers in the tier. Generally, the RDBMS database server will host a SQL (structured query language) database, although this is not limiting. One of many well-known SQL database server products may be used to host database 1014, such as the database servers produced by Oracle (e.g., Oracle 10i), Microsoft (SQL server 7 and 2003), IBM (DB2), Informix, Sybase, etc. Open source products, such as those SQL databases produced by MySQL may be used as well. Optionally, non-SQL databases may be used.

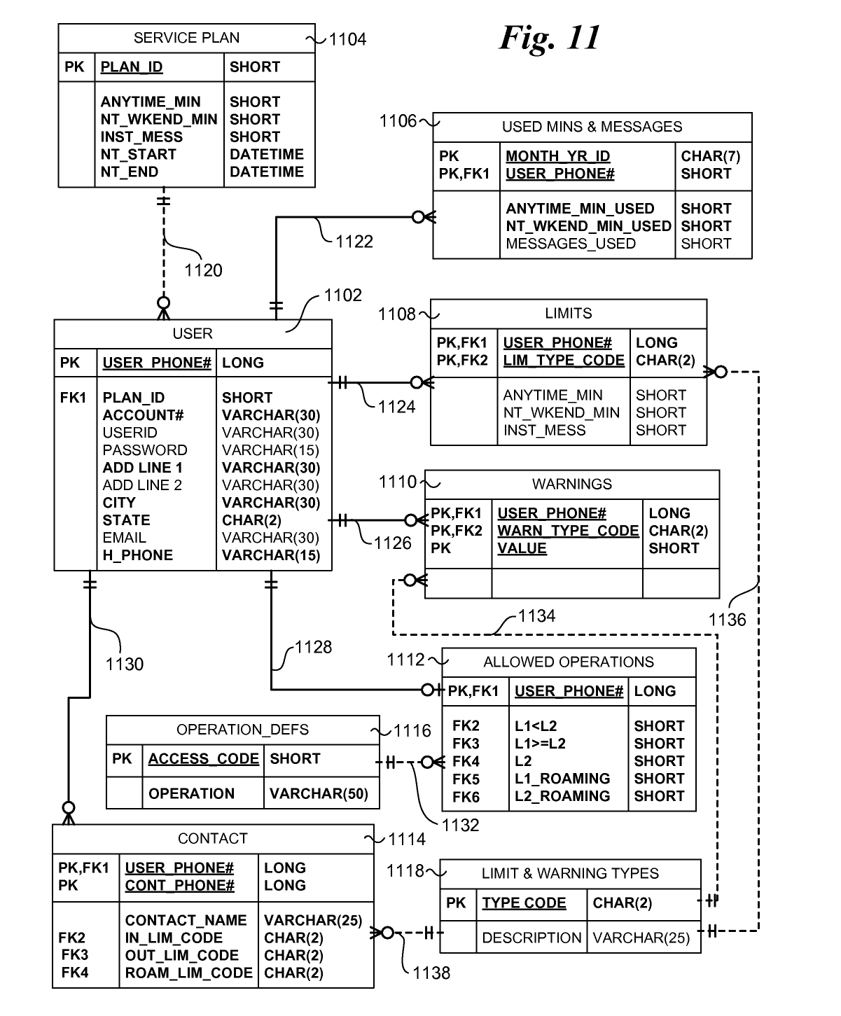

With reference to FIG. 11, a data model 1100 corresponding to a portion of an exemplary database schema that may be employed to support cellular device access control at the service provider level is shown. The schema includes a USER table 1102, a SERVICE PLAN table 1104, a USED MINS & MESSAGES table 1106, a LIMITS table 1108, a WARNINGS table 1110, an ALLOWED OPERATIONS table 1112, and CONTACT table 1114, an OPERATIONS DEFS table 1116 and a LIMIT & WARNING TYPES table 1118. These tables are linked by one-to-many relationships 1120, 1122, 1124, 1126, 1130, 1132, 1134 and 1136, and one-to-one relationship 1128. In addition to the tables illustrated, the database schema may generally include various tables for storing data pertaining to typical service center operations, such as switching, cellular network management, billing, etc; these tables are not shown for clarity.

Basic user information is stored in USER table 1102 under corresponding columns. These include the user's cellular device number (primary key (PK) USER_PHONE#), service plan identifier (PLAN_ID), account number (ACCOUNT#), user identifier for using the web site (USERID), and corresponding password for the web site use (PASSWORD). In addition, USER table 1102 may be used to store further user information, such as mailing address, email address, home and work phone numbers, etc. Optionally, this further information may be stored in another table that is linked with USER table 1102 via a foreign key reference to the USER_PHONE# primary key (not shown).

Service plan details are stored in SERVICE PLAN table 1104. Each service plan offered by the service provider is identified via a unique plan identifier (PLAN_ID), which serves as the primary key for the table. Each respective record for the available plans will include various parameters corresponding to that plan, such as the number of anytime minutes (ANYTIME_MIN), the number of night and weekend minutes (NT_WKEND_MIN), the number of free text (or instant) messages (INST_MESS), and the start and end times (NT_START and NT_END, respectively) used to delineate night mode from day mode. In addition to the exemplary columns shown, other columns may be included depending on the types of service plans offered by the service provider.

The various cumulative running totals of used minutes and messages are stored in USED MINS & MESSAGES table 1106. The primary key for the table is a composite key made of a MONTH_YR_ID column and a USER_PHONE# column. Basically, running totals will be kept for each registered user for each billing cycle, wherein the billing cycle is identified in the MONTH_YR_ID column (e.g., MAR2003). Definitions for the billing cycle start and end dates for a particular user will typically be stored in another table pertaining to customer billing (not shown). In accordance with the foregoing example, used anytime minutes will be stored in an ANYTIME_MIN_USED column, and used night and weekend minutes will be stored in the NT_WKEND_MIN_USED column. If a limit on text messages is applicable, the running total for text message usage for the given billing period will be stored in the MESSAGES_USED column.

User-defined limits are stored in LIMITS table 1108. The LIMITS table has a composite primary key including USER_PHONE# and LIM_TYPE_CODE columns. Examples of limit types codes are level limit identifiers, such as L1 and L2, and text messages limits. The description for each limit type code is stored in LIMIT & WARNING TYPES table 1118, which is liked to the LIMITS table via is TYPE_CODE primary key. The various user-defined limit values are stored in the ANYTIME_MIN, NT_WKEND_MIN, and the INST_MESS columns, as appropriate for the limit type. This enables a set of limits values to be stored for each type of limit, per user.

In a similar manner, user-defined warnings are stored in WARNINGS table 1110. In the illustrated embodiment, the WARNINGS table includes a three-column primary key defined by the USER_PHONE#, WARNING TYPE, and VALUE columns. Recall from above that more than one warning may be provided for a given usage mode, such as shown in text/edit box 528 of FIG. 5. By using the VALUE column in the composite primary key, the same warning value may not be entered for the same type of warning for the same user. The descriptions for the various warning types are stored in LIMIT & WARNING TYPES table 1118.

Allowed operations, which pertain to operations the target user is allowed to perform under various user mode conditions, are stored in ALLOWED OPERATIONS table 1112. This table includes a USER_PHONE# primary key column, implying that there is one set of allowed operations for each user. The various non-key columns in the table map to corresponding fields on frame 606 of FIG. 6. For example, the allowed operation for a given user when Level 1 user mode has kicked in prior to reaching the Level 2 user mode is stored in the L1<L2 column. In the illustrated embodiment, the actual operation definitions are stored in OPERATION_DEFS table 1116, and the value stored in the various non-key columns is an access code that is mapped to the ACCESS_CODE column of the OPERATION DEFS table through a lookup operation that links the ACCESS_CODE values with a corresponding operation definition stored in the OPERATION column. For example, the operations may include blocked, 3 minute limit, 5 minute limit, etc.

User contact information is stored in CONTACT table 1114, which employs the combination of the user's cellular phone number (USER_PHONE#) and the contact's cellular phone number (CONT_PHONE#) as its primary key. The non-key columns includes a CONTACT_NAME column for storing the contacts name and IN_LIM_CODE (incoming limit code), OUT_LIM_CODE (outgoing limit code), and ROAM_LIM_CODE (roaming limit code) columns for storing the respective access level assignment codes for the contact corresponding to the same information entered in the INCOMING, OUTGOING and ROAMING columns of frame 602 in FIG. 6, respectively. The LIMIT & WARNING TYPES table is again used as a lookup for the access level assignment code types.

### Central Service Center Run-Time Operations

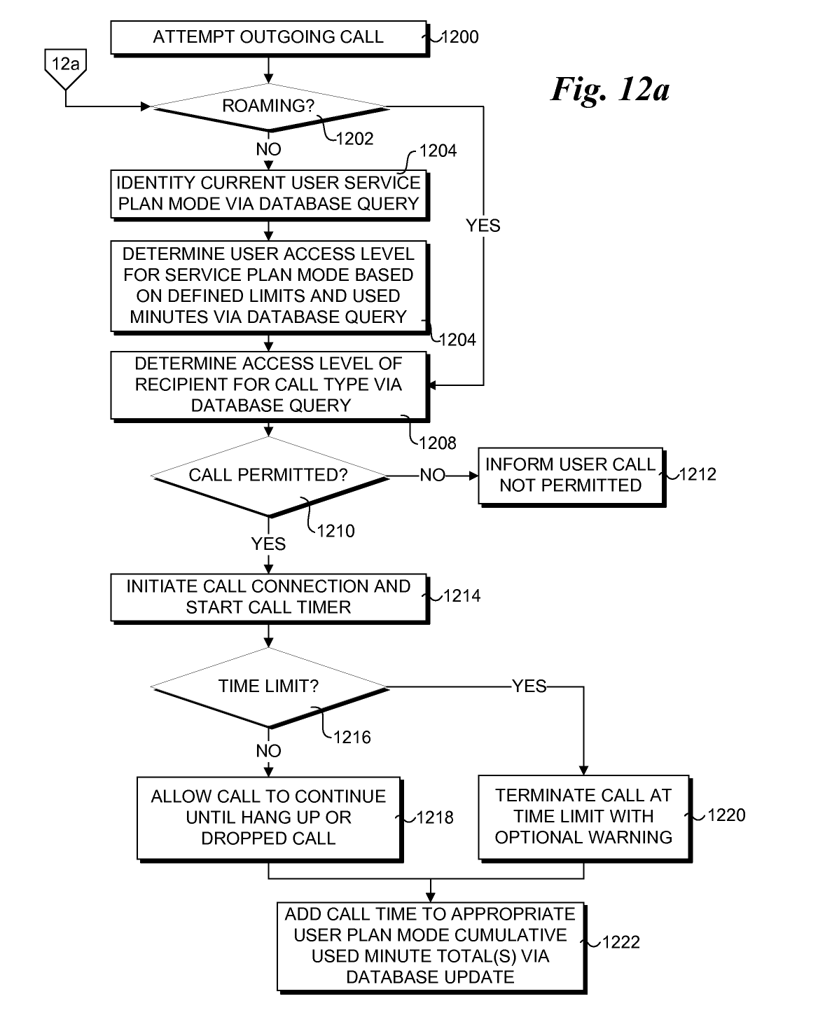

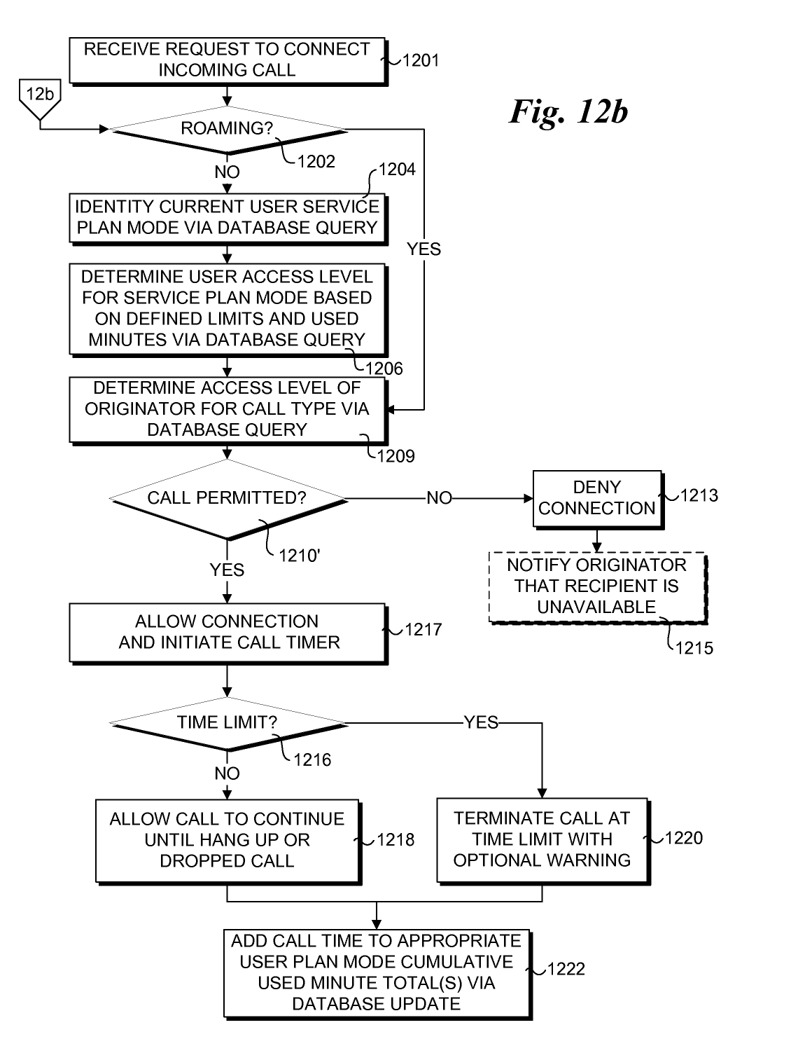

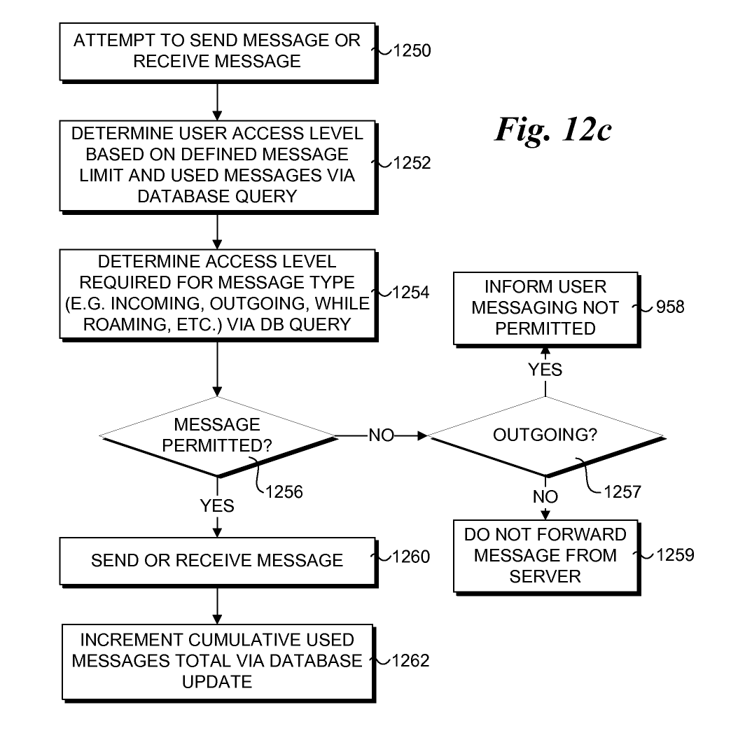

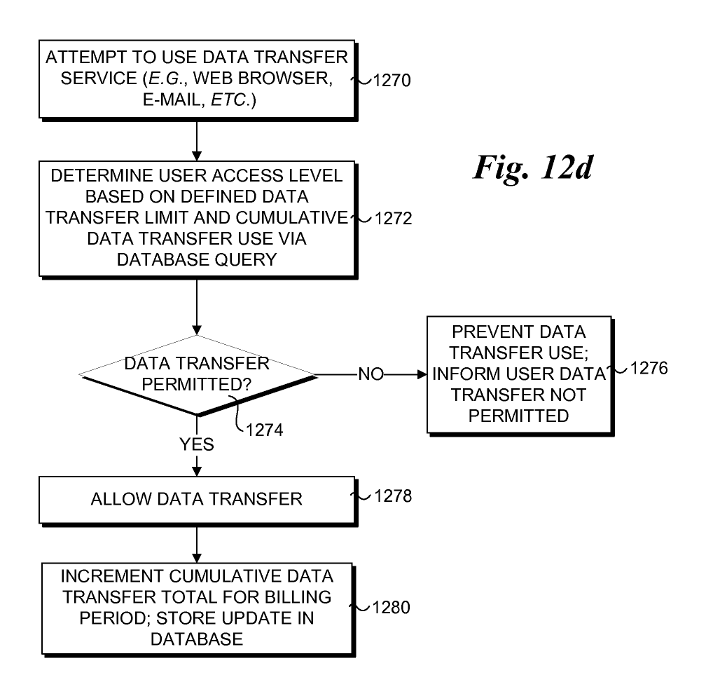

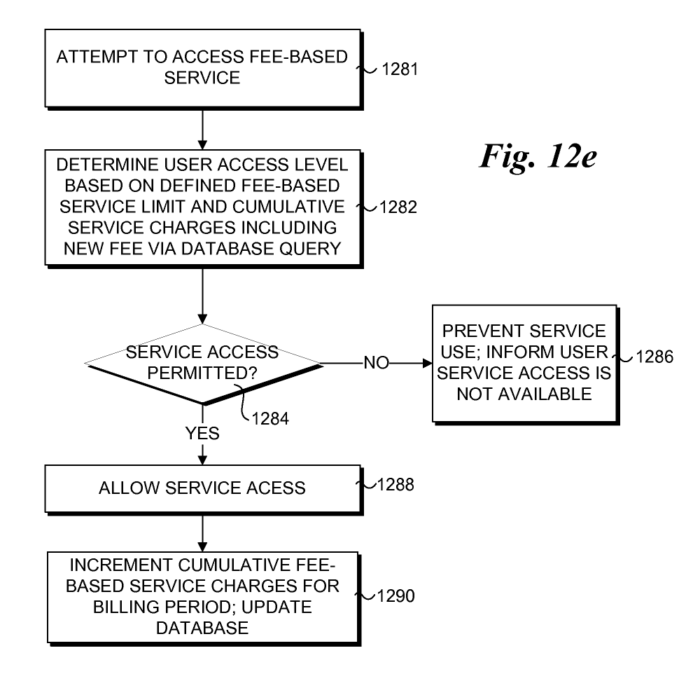

With reference to the flowchart of FIG. 12a, the following operations are performed in response to a target user initiating an outgoing call. At a high level, the operations are substantially similar to those discussed above with reference to the flowchart of FIG. 9a; however, the underlying operations are performed via the central service center and/or satellite service center rather than by the cellular device.

In response to a target user's attempt to send an outgoing call in a block 1200, a determination is made in a block 1202 to whether the user is roaming. This decision can generally be made by identifying the cell site via which the user is connected to the cellular network. If the cell site is operated by the service provider (or another service provider partnered with the service provider for sharing infrastructure such the no roaming exists) then the user is not roaming (under most of today's service plans). If the cell site is operated by another non-partner service provider, the user will generally be roaming. If the user is roaming, the logic proceeds to a block 1208 discussed below.

If the user is not roaming the current service plan mode for the user is identified in a block 1204. This can be accomplish via a database lookup involving the USER and SERVICE PLAN tables to obtain the night start and end times for the user's service plan and then comparing the returned times with the current time to determine whether the night mode is applicable:

QUERY 1

SELECT NT_START, NT_END INTO night_start, night_end
FROM SERVICE PLAN
WHERE PLAN_ID = (SELECT PLAN_ID FROM USER
WHERE USER_PHONE# = Current_User_Phone#);

If the night mode is not applicable, a second query is performed to determine if the weekend mode is in affect. If desired, both queries may be combined, along with the logic for determining if the current time falls within either the night or weekend modes defined for the user's service plan.

Next, in a block 1206 the user access level for the plan mode is determined based on the defined limits of the mode and the used minutes for the current billing period. For example, if the user service plan mode is anytime minutes the following query may be used:

QUERY 2

SELECT nvl(LIMIT_TYPE, L1) into User_Access_Level FROM
LIMITS WHERE ANYTIME_MIN IN (SELECT MAX
ANYTIME_MIN FROM LIMITS WHERE USER_PHONE# =
Current_User_Phone# AND
ANYTIME_MIN < (SELECT ANYTIME_MIN_USED FROM
USED MINS & MESSAGES WHERE PHONE# =
Current_User_Phone#
AND MONTH_YR_ID = Current_billing_cycle_ID));

This exemplary query uses the Oracle “nvl” function to return a default level of L1 if the used minutes have not reached the Level 1 (L1) threshold defined for the user, will return a value of L2 (Level 2) if the threshold for Level 1 has been exceeded but the threshold for level to has not, and will return a value of E if the thresholds for both Level 1 and Level 2 have been surpassed. A similar query may be used for night and weekend minutes service plan modes.

At this point the logic proceeds to block 1208, or may have reached this block if the user is roaming. In block 1208 the access level of the recipient for the call is determined;

QUERY 3

SELECT OUT_LIM_CODE into Recipient_Access_Level FROM
CONTACT WHERE USER_PHONE# = Current_user_Phone# AND
CONT_PHONE# = Recipient_Phone#;

Once the User_Access_Level and Recipient_Access_Level (codes) are retrieved, a determination of whether the call is permitted is made in a decision block 1210 based on access operation rule logic defined in FIG. 13, in a manner similar to that discussed above with reference to block 910 in the flowchart of FIG. 9A. For example, if the User_Access_Level is L2, the user can make an outgoing call to HOME, but may not make a call to AMY (based on the values shown in FIG. 6).

If the call is not permitted, the user is informed via the service provider in a block 1212. For example, the service provider can send a verbal message to the user's phone stating, “This call is not permitted—you have exceeded the use limit to allow a call to this recipient.” As an option, the service provider can use a text-to-speech (TTS) module to substitute the recipient's name (retrieved from the CONTACT table) in place of “this recipient” in the verbal message.

If the call is permitted, the call is initiated and the call timer is started in a block 1214. (It is noted that if the call involves the use of cellular infrastructure operated by another service provider (such as when the user is roaming or the recipient uses a different service provider than the user, various connection operations between the user's service provider and the other service provider(s) will be performed prior to enabling the call connection will be performed in the normal manner for these types of calls; routing and connection details for this are not shown herein for clarity). In a block 1216 a determination is made to whether a time limit is applicable. If no time limit is applicable, the logic proceeds to a block 1218 in which the call is allowed to continue until a call-ending event occurs, such as one of the call participants hanging up or the call being dropped. If a time limit is applicable, the call is terminated at the call limit time in a block 1220 via an action taken by the service provider (e.g., intentionally dropping the call). As an option, one or more warnings may be provided during the call to let the user know the call is about to be terminated. In either case, at the end of the call the call time is added to the cumulative running total of used minutes for the current service plan mode in a block 1222. This is performed using a simple update query on the USED MINS & MESSAGES table, whereby the time used for the current call is added to the cumulative total for the user's current billing cycle and the current service plan mode. It is further noted that these cumulative totals are automatically reset to 0 at the beginning of each new billing cycle using a trigger, script, or the like.

It is noted that in the foregoing example, various operations where performed at the service provider's central service station. Such operations may also be performed at a satellite service center or portions of the operations may be distributed between the two. This may be enabled by replicating all or applicable portions of database 1014 across the satellite service centers, thereby providing each satellite service center with a local copy of the applicable database data.

Operations pertaining to handling an incoming call via service provider operations are shown in the flowchart of FIG. 12b, wherein operations performed in both FIG. 12a and FIG. 12b have like reference numbers. In addition, many of the operations in the blocks of FIG. 12b are analogous to operations discusses above with reference to the flowchart of FIG. 9b, except that the operations are performed via the service provider rather than via the cellular device.

The process begins in a block 1201 in which a request for an incoming call connection is received by the service provider. This request may be made via an originating (of the call) user having the same service provider as the target user, or a different service provider in a conventional manner well-known in the art. The operations of decision block 1202 and blocks 1204 and 1206 are similar to those discussed above for outgoing calls. In a block 1209, the access level of the originator for the call types may be determined via the following database query;

QUERY 4

SELECT IN_LIM_CODE into Originator_Access_Level FROM
CONTACT WHERE USER_PHONE# = Current_user_Phone# AND
CONT_PHONE# = Originator_Phone#;

In a block 1210′, a determination is made to whether the call is permitted. This determination is performed in a manner similar to that discussed above for decision block 1210, except in this instance the access level to be considers pertains to a call originator rather than a call recipient. If the call is not permitted, the connection is denied in a block 1213, and (optionally) the originator is notified that the recipient is unavailable in a block 1215. If the call is permitted, the connection is allowed, and the call timer is initiated in a block 1217. The rest of the operations in decision block 1216 and blocks 1218, 1220, and 1222 are performed in a similar manner to that discussed above with reference to FIG. 12a.

As above, service provider operations are available for controlling access to data transfers and fee-based content. Details of illustrated operations for controlling access to data transfers and fee-based content are shown in FIGS. 12d and 12e, respectively. The operations are similar to that discussed above with reference to FIGS. 9d and 9e respectively, where like operations include a reference number sharing the last two digits. For example, the operations of blocks 970 and 1270 are analogous. The primary difference between the analogous methods is the service provider-based control scheme accesses data from the database other than local memory, and service access is allowed or prevented at the applicable mobile service network infrastructure rather than at the mobile device.

It is noted that additional functionality can be added in addition to that shown in the flowcharts of FIGS. 9a-e and 12a-e; such functionality is not included in the flowcharts for clarity. For example, some of today's plans provide free “in-network” calls, meaning calls between mobile phones using the same service provider do not incur any charges. Accordingly, logic would be provided via the mobile phone and/or the service provider database, as applicable, such that this free airtime was not added to the billing cycle usage for determining usage levels. Similarly, some plans allow unlimited calls to five “faves” within the network, while others allow unlimited calls to selected users that may be in or out of the network. Similar plans exist for text messaging. As before, logic would be provided for handling recording or no recording airtime usage or text messaging based on the applicable plan rules.

In addition, flexible rules may be defined that go beyond all or nothing limits. As discussed above, call-lengths may be automatically limited under corresponding rules. Similarly, this could be applied to data transfers and fee-based services. For example, rules could be defined that would allow a predefined amount of data transfers related to Web access (e.g., 1 MB) at a time after a usage level threshold is met. In combination with this, the user would only be able to access the amount on a periodic basis—such as 1 MB per day. Similar rules could be defined for fee-based services—such as $1 per day after a certain service usage level has been billed for a given billing period.

As another option, rule sets could be defined to employ dynamic considerations. For example, suppose under a first scenario a user used a predetermined level of text messages during the first 10 days of a month, while in a second scenario the predetermined level was not reached until 25 days. The “extra” per day number of allowed text messages could be dynamically calculated to meet and overall target usage level. Under this situation, the user or used up the text messages in the first 10 days might be limited to 10 messages per day for the rest of the billing period, while the user who didn't reach the level until 25 days might be allowed 40 messages per day for the rest of the billing period.

It is further contemplated that warnings could be provided to supervisor users as well as their target users. For example, suppose a user triggers a warning trip point or reaches a usage level threshold. A text message could be sent to the supervisor user's mobile device informing him or her of the situation. The supervisor might even be provided with the option to extend a usage level threshold or otherwise change a usage rule by simply replying to the message with corresponding indicia in accordance with the message. For instance, the message could provide the option for adding 10 minutes, 20 minutes, 30 minutes, etc. by replying with a value of 10, 20, 30, etc. in the message header or message body. For more advanced mobile devices, such as the Apple iPhone™, an e-mail message could be sent to the supervisor user including a link to a page in a Web portal via which increased limits could be entered. Upon a change in usage limits, an automatically generated text message or voicemail could be sent to the target user's mobile device to apprise the user of the limit change. Of course, such warning functions could be selectively configured by the supervisor user, such as via the Web portal, the mobile device, or an application.

### Support for Multi-Mode Mobility

Licensed wireless systems provide mobile wireless communications to users of wireless transceivers such as cellular phones. In general, licensed wireless systems refer to public cellular telephone systems and/or Personal Communication Services (PCS) telephone systems. Wireless transceivers generally include cellular telephones, PCS telephones, wireless-enabled personal digital assistants, wireless modems, pocket PC's, and the like.

Licensed wireless systems utilize wireless signal frequencies that are licensed from governments, hence the name. Large fees are paid for access to these frequencies. Expensive base station (BS) equipment is used to support communications on licensed frequencies. Base stations are typically installed approximately a mile apart from one another (e.g., cellular towers in a cellular network), although picocells may implement closer spacing. The wireless transport mechanisms and frequencies employed by typical licensed wireless systems limit both data transfer rates and range. As a result, the quality of service (voice quality and speed of data transfer) in licensed wireless systems is considerably inferior to the quality of service afforded by landline (wired) connections. Thus, the user of a licensed wireless system pays relatively high fees for relatively low quality service.

Landline (wired) connections are extensively deployed and generally perform at a lower cost with higher quality voice and higher speed data services. The problem with landline connections is that they constrain the mobility of a user. Traditionally, a physical connection to the landline was required.

In the past few years, the use of unlicensed wireless communication systems to facilitate mobile access to landline-based networks have seen rapid growth. For example, such unlicensed wireless systems may support wireless communication based on the IEEE 802.11a, b or g standards (a.k.a. WiFi), or the IEEE 802.16x (a.k.a. WiMAX) draft and future standards. The mobility range associated with WiFi systems is typically on the order of 300 meters or less, while proposed WiMAX mobility is predicted to be an order of magnitude or more higher. A typical unlicensed wireless communication system includes a base station comprising a wireless access point (AP) with a physical connection (e.g., coaxial, twisted pair, or optical cable) to a landline-based network. The AP has a RF transceiver to facilitate communication with a wireless handset that is operative within a modest distance of the AP, wherein the data transport rates supported by the WiFi and WiMAX standards are much higher than those supported by typical cellular service. Thus, this option provides higher quality services at a lower cost, but the services only extend a modest distance from a given base station.

Currently, technology is being developed to integrate the use of licensed and unlicensed wireless systems in a seamless fashion, thus enabling a user to access, via a single handset, an unlicensed wireless system when within the range of such a system, while accessing a licensed wireless system when out of range of the unlicensed wireless system. In order to support more rapid implementation by various vendors, a standardized set of messages for performing various functions, such at registration, channel activation, handover, and the like are being developed.

In the present description the unlicensed wireless system may be a short-range wireless system, which may be described as an “indoor” solution. However, it will be understood through the application that the unlicensed wireless system includes unlicensed wireless systems that cover not only a portion of a building but also local outdoor regions, such as outdoor portions of a corporate campus serviced by an unlicensed wireless system. The mobile station may, for example, be a wireless phone, smart phone, personal digital assistant, or mobile computer. The “mobile station” may also, for example, be a fixed wireless device providing a set of terminal adapter functions for connecting Integrated Services Digital Network (ISDN) or Plain Old Telephone Service (POTS) terminals to the wireless system. Application of the present invention to this type of device enables the wireless service provider to offer so-called landline replacement service to users, even for user locations not sufficiently covered by the licensed wireless system. The present description is in the context of the UMA (Unlicensed Mobile Access) standardized architecture as promulgated by the UMA consortium. However, the invention is not so limited.

Throughout the following description, acronyms commonly used in the telecommunications industry for wireless services are utilized along with acronyms specific to the present invention. A table of acronyms is included in Appendix I.

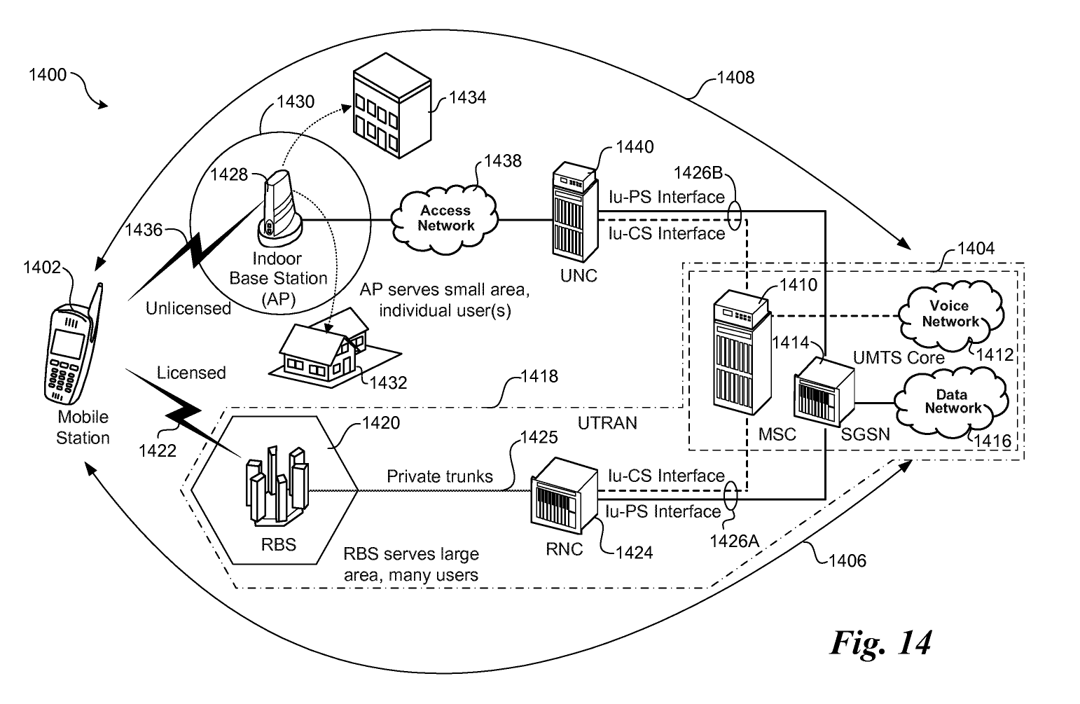

FIG. 14 illustrates an Unlicensed Mobile Access (UMA) architecture 1400 with extended features to support inter-working with a UMTS (Universal Mobile Telecommunication System) core network (CN), in accordance with one embodiment. With respect to aspects of this disclosure, the use of the term “extended” relates to extension to UMA architecture embodiments described in published UMA specifications to support inter-working with UMTS core networks. In general, these prior embodiments support UMA access to GSM (Global System for Mobile Communication) core networks. Such extended functionality may be identified by adding a “+” symbol to some components, indicating that such components support both UMTS and GSM network access. At the same time, it will be recognized that implementation of various components to support only UMTS network access are also contemplated. For simplicity and clarity, only those aspects related to UMTS network access are disclosed herein. Details for supporting UMA access to GSM networks are disclosed in applicable UMA specifications.

UMA architecture 1400 enables a user of a mobile station 1402 to access a UMTS core network 1404 via either a licensed wireless communications session 1406, or an unlicensed wireless communication session 1408. The UMTS core network 1404 is depicted to include a Mobile services Switching Center (MSC) 1410, which provides access to a voice network 1412, and a Serving GPRS (General Packet Radio Service) Support Node (SGSN) 1414, which provides access to a data network 1416. In addition, the UMTS core network may include various other components typically implemented in UMTS networks, as are well-known in the art.

In further detail, the licensed wireless communication session is facilitated by infrastructure provided by a licensed wireless network 1418 that includes UMTS core network 1404. In the illustrated embodiment, licensed wireless network 1418 depicts components common to a UMTS-based cellular network that includes multiple Radio Base Stations (RBS) 1420 (of which only one is shown for simplicity) that facilitate wireless communication services for various mobile stations 1402 via respective licensed radio links 1422 (e.g., radio links employing radio frequencies within a licensed bandwidth). Under UMTS, a Radio Base Station is commonly referred to as “Node B.” Typically, the multiple RBSs 1420 are configured in a cellular configuration (one per each cell) that covers a wide service area. The various RBSs 1420 for a given area or region are managed by a Radio Network Controller (RNC) 1424, with each RBS 1420 communicatively-coupled to its RNC 1424 via a private trunk 1425. In general, a large licensed wireless network, such as that provided by a regional or nationwide mobile services provider, will include multiple RNCs 1424. The RBSs 1420 and RNCs 1424 collectively comprising a UMTS Terrestrial Radio Access Network (UTRAN).

The UMTS core network is divided in circuit-switched and packet-switched domains. Some of the circuit-switched elements include MSC 1410, Visitor Location Register (VLR) and Gateway MSC (latter two both not shown). Packet-switched elements include SGSN 1414 and Gateway GPRS Support Node (GGSN) (not shown). Some network elements, such as EIR, HLR, VLR and AUC (all not shown) are shared by both domains.

The Asynchronous Transfer Mode (ATM) is defined for UMTS core transmission. ATM Adaptation Layer type 2 (AAL2) handles circuit switched connection and packet connection protocol AAL5 is designed for data delivery.

The architecture of the UMTS core network may change when new services and features are introduced. Number Portability DataBase (NPDB) will be used to enable user to change the network while keeping their existing phone number. Gateway Location Register (GLR) may be used to optimize the subscriber handling between network boundaries. In addition, an MSC may be configured to implement MSC, VLR and/or SGSN to become a UMTS MSC.

Each RNC 1424 communicates with UMTS core network 1404 through a standard RNC interface 1426. For example, a RNC 1424 may communicate with MSC 1410 via the lu-CS (circuit-switched) interface for circuit switched voice services and with SGSN 1414 via the lu-PS (packet-switched) interface for packet data services. The UMTS core network 1404 includes protocols to permit seamless handoffs from one serving RNC 1424 to another RNC (not shown) to provide mobile access across cells.

An unlicensed communication session 1408 is facilitated via an (wireless) access point (AP) 1428 comprising an indoor base station 1430. Typically, AP 1428 will be located in a fixed structure, such as a home 1432 or an office building 1434. The service area of indoor base station 1430 generally includes an indoor portion of such a home or building, although it will be understood that the service area of an indoor base station may include an outdoor portion of a building or campus. As indicated by the arrow representing unlicensed communication session 1408, the mobile station 1402 may be connected to UMTS core network 1404 via a second data path that includes an unlicensed wireless channel 1436, access point 1428, an access network 1438, and an unlicensed mobile access network controller (UNC) 1440. The UNC 1440 communicates with UMTS core network 1404 using a RNC interface 1426B that is similar to RNC interface 1426A, and includes an lu-CS interface and an lu-PS interface. AP 1428 may include software entities stored in memory and executing on one or more microprocessors (not shown in FIG. 14A) adapted to perform protocol conversion. In one embodiment, AP 1428 comprises a standard unlicensed access point (e.g., WiFi, Bluetooth™, etc.).

The unlicensed wireless channel 1436 is facilitated by a radio link employing a wavelength (or wavelength range) in an unlicensed, free spectrum (e.g., spectrum around 2.4 GHz, 5 GHz, 11-66 GHz). An unlicensed wireless service hosting unlicensed wireless channel 1436 may have an associated communication protocol. As examples, the unlicensed wireless service may be a Bluetooth™ compatible wireless service supporting a Bluetooth personal local area network (PLAN), or a wireless local area network (LAN) (WiFi) service (e.g., the IEEE 802.11a, b, or g wireless standard). This provides the user with potentially improved quality of service in the service regions of the unlicensed wireless service (i.e., within the service range of a corresponding AP). Thus, when a subscriber is within range of the unlicensed AP, the subscriber may enjoy low cost, high speed, and high quality voice and data services. In addition, the subscriber enjoys extended service range since the handset can receive services deep within a building at locations that otherwise may not be reliably serviced by a licensed wireless system. At the same time, the subscriber can roam outside the range of the unlicensed AP without dropping communications. Instead, roaming outside the range of the unlicensed AP results in a seamless handoff (also referred to as a handover) wherein communication services are automatically provided by the licensed wireless system, as described in more detail in U.S. Pat. No. 6,922,559, the contents of which are hereby incorporated by reference.

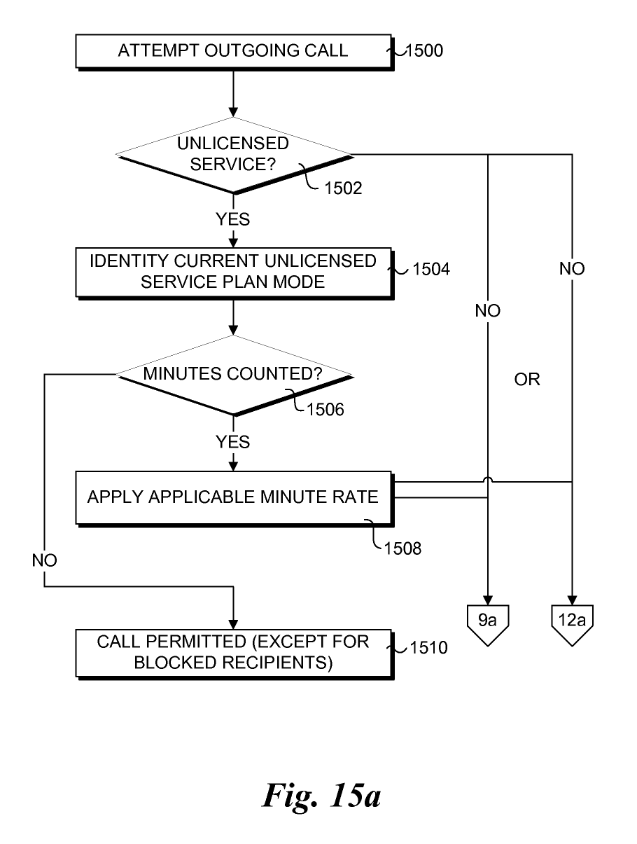

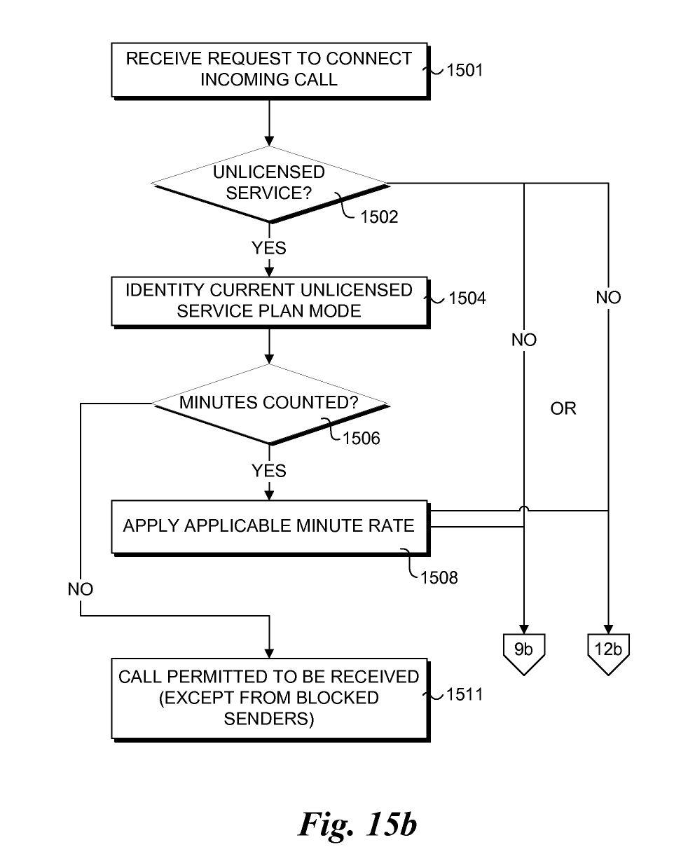

FIG. 15a shows a flowchart illustrating logic and operations performed in response to attempting an outgoing call using a dual-mode handset, wherein the modes include a licensed mode and an unlicensed mode. For example, Nokia, among others, produces dual-mode handsets that include support for 802.11 access (i.e., the unlicensed mode). In future phones, the unlicensed mode may include a WiMAX mode. Other future unlicensed modes may also be employed in a similar manner.

The outgoing call process begins in a block 1500 in which a user attempts to place an outgoing call. In response, a determination is made in a decision block 1502 to whether the user is currently using an unlicensed service (e.g., wireless network access is provided by a WiFi Access Point or a WiMAX base station). If the user is currently using his or her mobile service provider, the logic proceeds to jump to the flowchart of FIG. 9a or 12a, as applicable (i.e., depending on whether the mobile phone itself is controller access or the service provider is controlling access). Thus, the operations would proceed in the same manner as described above for the applicable flowchart.

If the mobile phone is currently accessing the network via an unlicensed service, the logic flows to a block 1504 in which the current unlicensed service plan mode is identified. For example, T-Mobile recently introduced unlicensed WiFi access points for its subscribers. Under the initial mode, calls initiated using a T-Mobile WiFi access point incurred no charges, including if a later handover was made to the mobile network when the mobile phone was moved out of range of the access point. Conversely, calls initiated via the mobile network were billed for the complete call duration, including any portion of a call that was made after a handover to a T-Mobile WiFi access point. Other service plans may charge a different rate for WiFi access as compared with mobile network access, such as a lower per-minute rate.

In accordance with the unlicensed service plan mode identification in block 1504, a determination is made in decision block 1506 to whether the plan counts minutes against the mobile service plan. If so, the applicable minute rate is applied in a block 1508, and the operation proceed to the flowchart of FIG. 9a or 12a, as applicable. In one embodiment, the minute count rate will be a fraction of that used by the mobile network, e.g., every three minutes using unlicensed service will count toward one minute of mobile network airtime.

If the minutes are not counted, the call is permitted, as shown in a block 1510. In one embodiment, calls to blocked recipients will still be blocked, regardless of whether or not minutes are counted.

As shown in the flowchart of FIG. 15b, the logic and operations associated with receiving an incoming call with a dual-mode handset are similar to that used for outbound calls. The process begins in a block 1501, wherein a request to connect an incoming call is received. In response, a determination is made in decision block 1502 to whether the current service is an unlicensed service. If the service is currently being provided by the mobile network, the logic proceeds to the flowchart of FIG. 9b or 12b as applicable, and the operations of those flowcharts are performed to determine whether or not that call is allowed to be received.

As before, if the current service is an unlicensed service, the unlicensed service plan is identified in block 1504, and a determination is made to whether or not minutes are counted. If so, the applicable rate is applied in block 1508, and the logic proceeds to the flowcharts of FIG. 9b or 12b, as applicable. If the minutes are not counted, the call is permitted in accordance with a block 1511. In one embodiment, calls from blocked senders may not be received regardless of whether the minutes are counted.

As discussed above, one aspect of UMA-type service is the ability to perform handovers between unlicensed service and licensed service and vice-versa. This creates another situation to handle in the event the WiFi access is free (actually free or is included as part of an unlimited service for a fixed fee, so is not charged by the minute) while the licensed mobile service is not.

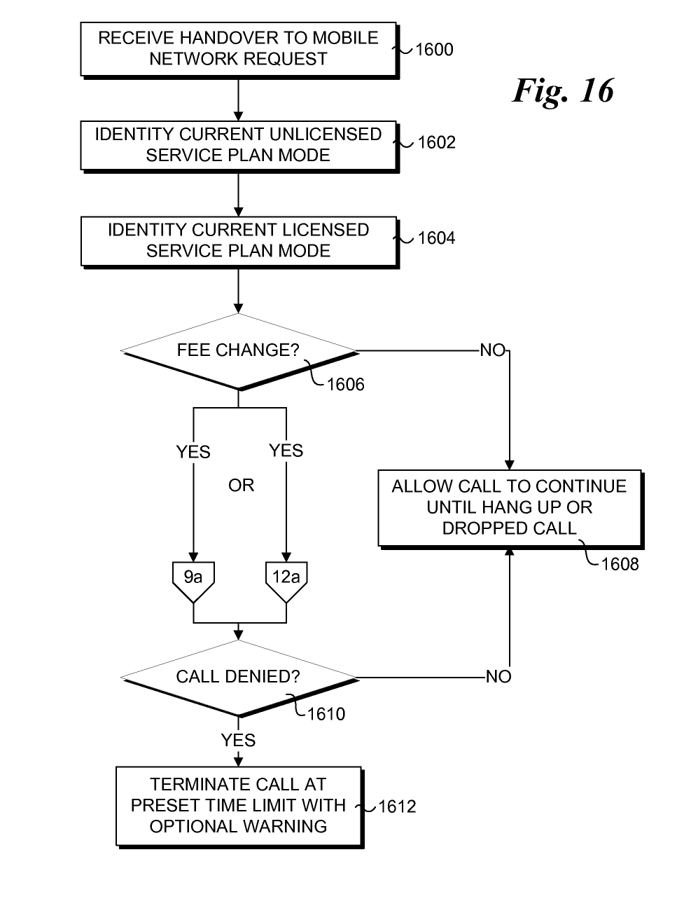

FIG. 16 shows a flowchart illustrating an exemplary handover from as unlicensed service to a licensed service. The process begins in a block 1600, wherein a request to handover service to a mobile network is received while being serviced with an unlicensed service. In response, the current unlicensed and licensed service plan modes are respectively checked in blocks 1602 and 1604. In view of the identified plan modes, a determination is made in a decision block 1606 to whether there is a fee change. For example, the fee would go from free to a per-mute charge for the mobile network service. If there is no fee change, the call is allowed to be continued until hang up or the call is dropped, as shown in a block 1608.

Conversely, if there is a fee change, the logic proceeds to the flowchart of FIG. 9a or 12a, as applicable, and is applied as if a new outgoing call is being attempted. However, in this case if the call is denied, as depicted by a decision block 1610, the existing call is terminated in a block 1612 after a preset time limit with an optional warning. For example, at the time the handover occurs, a warning could be displayed indicating the call will be dropped after n minutes. This would provide the user a chance to stay within range of the WiFi access point or WiMAX base station to complete the call. Moreover, in one embodiment, the handover to the mobile network could selectively prevented by the user via a corresponding user input to the mobile phone.

In general, handover from a licensed mobile network service to an unlicensed service will not create a need to change the current mode, as the latter will either be the same or less than the former. It is noted, that under applicable circumstances a call that normally would be terminated in consideration of a time limit when accessing licensed mobile network service may be continued if handed over to a free unlicensed service prior to expiration of the time limit.

### Exemplary Mobile Device Software Architectures

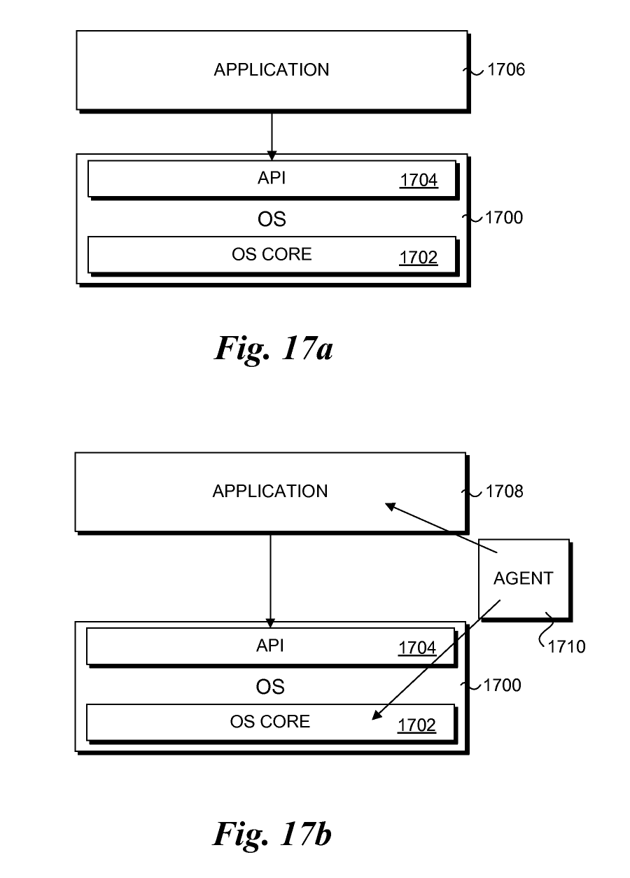

FIGS. 17a and 17b show high-level software architectures that may be implemented on cellular phones and other mobile devices to facilitate aspects of the phone-controlled embodiments disclosed herein. The architecture of FIG. 17a includes an operating system (OS) 1700 having an OS core 1702, and an application program interface (API) 1704. An application 1706 running in an “application layer” is used to implement various aspects of the embodiments. For example, application 1706 could implement the logic and operations of flowcharts 9a-c, as well as additional functionality described herein.

The architecture of FIG. 17b employs an agent 1710 and an application 1708 that work in concert with OS 1700 to facilitate the desired functionality. In one embodiment, agent 1710 is configured to “listen” for (i.e., detect) usage trigger events, such as incoming and outbound phone calls and text messages. The agent may further be configured to detect data transfer trigger events and fee-based download trigger events. In practice, agent 1710 would be configured to interface with one or more components in OS core 1702 to monitor various inbound and outbound operations, and to selectively enable operations in connection with sending and receiving phone calls, text messaging, data transfers, etc. to continue in accordance with the flowcharts and related discussion disclosed herein.

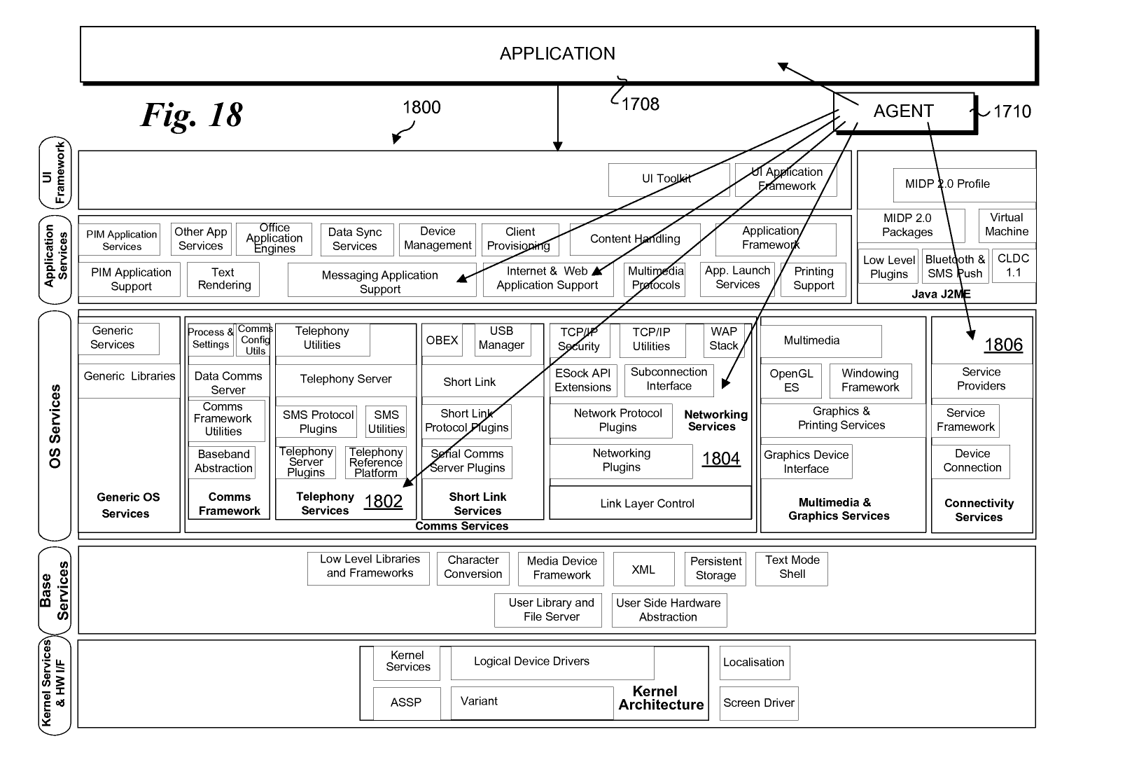

FIG. 18 shows details of a software architecture that may be implemented on a mobile phone using the Symbian operating system. In particular, FIG. 18 shows a Symbian OS model (v9) 1800. The Symbian operating system is a widely used open source operating system used on phones manufactured by vendors such as Nokia and Sony-Eriksson. The Symbian architecture employs a client-server model, where clients (i.e., applications) access services provided by various servers in the OS. The various interfaces are well-defined to support standardization, enabling third-party applications to be easily developed and implemented on the Symbian OS open-source platform.

As with the architecture of FIG. 17b, an agent 1710 is used to monitor and control various mobile phone usage by interfacing with various OS servers and services and application 1708. The exemplary services illustrated in FIG. 18 that agent 1710 monitors and/or controls include Telephony Services 1802, Networking Services 1804, and Connectivity Services 1806. Agent 1710 may also generally interface with various components in the Application Services layer, as shown.

In general, code corresponding to application 1708 and agent 1710 may be written in an object-oriented language, such as C++ or Java. Symbian provides a development toolkit to facilitate the development process, and the Symbian OS provides rich support for Java-based applications and applets. Typically, an application and optional agent may be provided with a mobile device during manufacture, or may subsequently be downloaded from a service provider, a Web site or from a local computer via a feature connector, USB link, Firewire link, or the like.

### Exemplary Cellular Phone Hardware Architecture

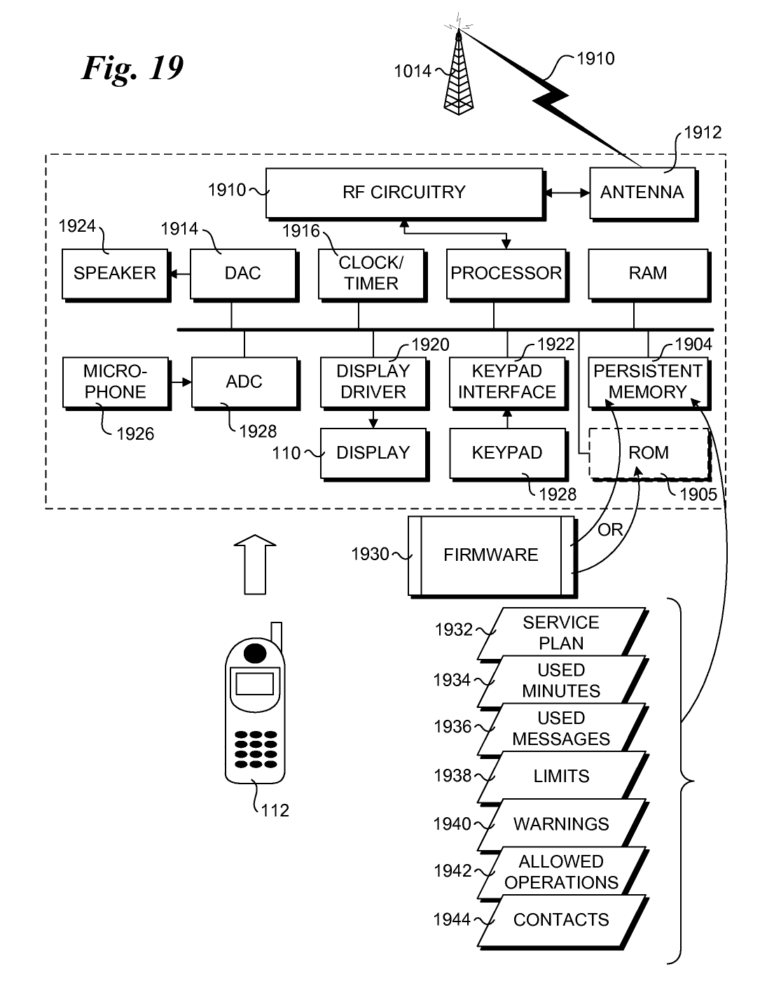

An exemplary hardware architecture for cellular phone 112 is accordance with one embodiment of the invention is shown in FIG. 19. At the heart of the architecture is a processor 1900, random access memory (RAM) 1902, and persistent memory 1904, which are linked in communication via a bus 1906. A read-only memory (ROM) component 1905 may also be included. Processor 1900 is coupled to radio-frequency (RF) circuitry 1908, which is configured to interface with incoming and outgoing RF signals 1910 having applicable wireless telephony wavelengths via an antenna 1912.

A digital-to-analog converter (DAC) 1914, a Clock/Timer 1916, and analog-to-digital converter (ADC) 1918, a display driver 1920, and a keypad interface 1922 are also connected to bus 1906. The DAC converts digital signals corresponding to (generally) incoming audio information and converts them into an analog waveform that is amplified and provided as a drive signal for a speaker 1924. A microphone 1926 picks up audio input (e.g., a user's voice) and generates an analog signal in response thereto that is converted into a digitized signal via ADC 1948. Display driver 1920 is used to drive display 110. User input entered via a keypad 1928 is processed by keypad interface 1922 and provided as a digital input to processor 1900 via bus 1906. Clock/Timer 1916 is used for keeping track of the current time and for call timing operations.

As will be recognized by those skilled in the electronic arts, the various functional components illustrated in FIG. 19 may be provided by discreet components, or may be integrated onto a single component or a plurality of modular components. For example, many modern cellular phones employ only a few chips for performing the operations of all of the functional blocks shown in FIG. 19. Typically, this will include a processor chip including built-in RAM and/or ROM in which firmware code 1930 is stored.

In accordance with embodiments of the invention that enable user access control via cellular phone operations (as apposed to service provider operations), various data for supporting these operations are stored in persistent memory 1904, also commonly referred to a non-volatile memory. As its name implies, persistent memory is enabled to store data whether the phone is operating (i.e. powered) or not, unlike RAM, which cannot store data without being powered. The persistent memory also should be rewritable. Examples of components that may be used for persistent memory 1904 include but are not limited to flash memory, and EEPROM devices. In one embodiment, persistent memory 1904 comprises a flash media card, having a standard form factor, such as the flash media cards used by digital cameras. The cellular phone may also have an interface for swapping out firmware modules as well (typically stored on a ROM or flash chip).

The various data stored in persistent memory 1904 include service plan data 1932, used minutes data 1934, used messages data 1936, limits data 1938, warnings data 1940, allowed operations data 1942, and contacts data 1944. In general, the various data will be stored in data structures common to typical software coding techniques. In some instances, a “flat-file” data storage architecture may be employed, where, unlike with an RDBMS database, data for most operations may be accessed from a single file (i.e., data structure), which will usually result in duplication of some types of data. Optionally, the data may be stored in a related set of data structures (i.e., tables) in a manner similar to an RDBMS database. However, in this instance the relational logic will generally be hard-coded into the firmware rather than handled by an RDBMS server component.

The operations and logic illustrated in the flowcharts of FIGS. 9a-c and 15a-b are implemented by corresponding executable instructions stored as firmware code 1930. Cellular phone 112 may also be configured to enable download of new firmware via a cellular signal. In this case, the new firmware will be stored in persistent memory 1904 rather than ROM 1905.

### Exemplary Server Computer System

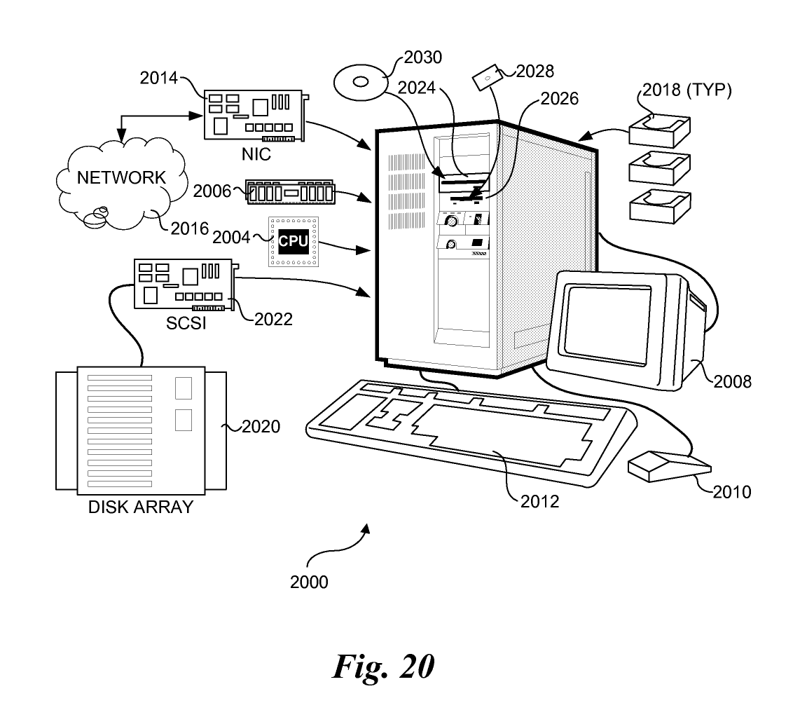

With reference to FIG. 20, a generally conventional computer server 2000 is illustrated, which is suitable for use in connection with practicing aspects of the present invention, and may be used for the various computer servers occupy web/network server tier 1002, application server tier 1004, and database server tier 1006 in FIG. 10. Examples of computer systems that may be suitable for these purposes include stand-alone and enterprise-class servers operating UNIX-based and LINUX-based operating systems, as well as computers running Microsoft Windows-based server operating systems.

Computer server 2000 includes a chassis 2002 in which is mounted a motherboard (not shown) populated with appropriate integrated circuits, including one or more processors 2004 and memory (e.g., DIMMs or SIMMs) 2006, as is generally well known to those of ordinary skill in the art. A monitor 2008 is included for displaying graphics and text generated by software programs and program modules that are run by the computer server. A mouse 2010 (or other pointing device) may be connected to a mouse port (or to a serial or USB port) on the rear of chassis 2002, and signals from mouse 2010 are conveyed to the motherboard to control a cursor on the display and to select text, menu options, and graphic components displayed on monitor 2008 by software programs and modules executing on the computer. In addition, a keyboard 2012 is coupled to the motherboard for user entry of text and commands that affect the running of software programs executing on the computer. Computer server 2000 also includes a network interface card (NIC) 2014, or equivalent circuitry built into the motherboard to enable the server to send and receive data via a network 2016.

File system storage corresponding to the invention may be implemented via a plurality of hard disks 2018 that are stored internally within chassis 2002, and/or via a plurality of hard disks that are stored in an external disk array 2020 that may be accessed via a SCSI card 2022 or equivalent SCSI circuitry built into the motherboard. Optionally, disk array 2020 may be accessed using a Fibre Channel link using an appropriate Fibre Channel interface card (not shown) or built-in circuitry.

Computer server 2000 generally may include a compact disk-read only memory (CD-ROM) drive 2024 into which a CD-ROM disk may be inserted so that executable files and data on the disk can be read for transfer into memory 2006 and/or into storage on hard disk 2018. Similarly, a floppy drive 2026 may be provided for such purposes. Other mass memory storage devices such as an optical recorded medium or DVD drive may also be included. The machine instructions comprising the software program that causes processor(s) 2004 to implement the operations of the present invention that have been discussed above will typically be distributed on floppy disks 2028 or CD-ROMs 2030 (or other memory media) and stored in one or more hard disks 2018 until loaded into memory 2006 for execution by processor(s) 2004. Optionally, the machine instructions may be loaded via network 2016 as a carrier wave file.

Thus, embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

APPENDIX I
Table Of Selected Acronyms

| | |
|---|---|
| AP | Access Point |
| BSC | Base Station Controller |
| BSS | Base Station Subsystem |
| BTS | Base Transceiver Station |
| CDMA | Code Division Multiple Access |
| CGI | Cell Global Identification |
| ETSI | European Telecommunications Standards Institute |
| FCC | US Federal Communications Commission |
| GERAN | GSM Edge Radio Access Network |
| GGSN | Gateway GPRS Support Node |
| GMM/SM | GPRS Mobility Management and Session Management |
| GMSC | Gateway MSC |
| GSM | Global System for Mobile Communication |
| GPRS | General Packet Radio Service |
| GSN | GPRS Support Node |
| HLR | Home Location Register |
| IAN | Indoor Access Network (see also UMA Cell) |
| IAN-RR | Indoor Access Network Radio Resource Management |
| IBS | Indoor Base Station. |
| IETF | Internet Engineering Task Force |
| INC | Indoor Network Controller |
| IP | Internet Protocol |
| ISDN | Integrated Services Digital Network |
| ISP | Internet Service Provider |
| MAC | Medium Access Control |
| MS | Mobile Station |
| MSC | Mobile Switching Center |
| POTS | Plain Old Telephone Service |
| PSTN | Public Switched Telephone Network |
| QoS | Quality of Service |
| RAN | Radio Access Network |
| RF | Radio Frequency |
| SAP | Service Access Point |
| SMC | Short Message Service Centre |
| SMS | Short Message Service |
| SM-SC | Short Message Service Centre |
| SMS-GMSC | Short Message Service Gateway MSC |
| SSL | Secure Sockets Layer |
| TCP | Transmission Control Protocol |
| UDP | User Datagram Protocol |
| UMA Cell | Unlicensed Mobile Access Cell (see also IAN) |
| UMTS | Universal Mobile Telecommunication System |
| UNC | UMA Network Controller (see also INC) |
| VLR | Visited Location Register |
| VMSC | Visited MSC |
| WLAN | Wireless Local Area Network |
| WSP IP | Wireless Service Provider's IP Network |

What is claimed is:

1. A method comprising:
enabling a supervisor user to specify parameters used to define a usage level-based rule set to control usage of a mobile device;
determining a current service plan mode in conjunction with establishing a call connection corresponding to an attempt to place an outgoing call or receipt of an incoming call page;
determining a current usage level corresponding to the service plan mode; and
applying an applicable rule from the usage level-based rule set based on a current usage level and the current service plan mode to allow or disallow establishment of the call connection.

2. The method of claim 1, further comprising storing data corresponding to the usage level-based rule set on the mobile device.

3. The method of claim 1, further comprising maintaining service usage data on the mobile device.

4. The method of claim 1, wherein the usage level-based rule set defines usage rules for at least two different usage levels for the same service parameter, the method further comprising:
determining a current usage level for the service parameter; and
applying an access rule based on the highest usage level defined for the service parameter the current usage level meets or exceeds.

5. The method of claim 1, wherein the usage level based rule set allows the supervisor user to restrict access to selected outgoing call recipients after an airtime usage level for a given billing cycle has been reached, the method further comprising:
identifying an intended recipient of an attempted outgoing call;
determining a current airtime usage level for the billing cycle; and
applying an applicable rule from the usage level-based rule set to determine whether to allow or deny the outgoing call to be connected based on the intended recipient and the current airtime usage.

6. The method of claim 1, wherein the usage level based rule set allows the supervisor user to restrict access to selected incoming call senders after an airtime usage level for a given billing cycle has been reached, the method further comprising:
identifying a sender of incoming call;
determining a current airtime usage level for the billing cycle; and
applying an applicable rule from the usage level-based rule set to determine whether to allow or deny the incoming call to be connected based on the sender recipient and the current airtime usage.

7. The method of claim 1, wherein the usage level-based rule set includes one or more warning trigger points, the method further comprising providing a warning when a usage level corresponding to a warning trigger point has been reached.

8. The method of claim 1, further comprising tracking service usage via the mobile device.

9. The method of claim 1, further comprising enabling the supervisor user to enter parameters used to define the usage level-based rule set via a Web portal.

10. The method of claim 1, further comprising enabling the supervisor user to enter parameters used to define the usage level-based rule set via the mobile device.

11. The method of claim 1, further comprising enabling usage level-based rule set data to be downloaded to the mobile device.

12. The method of claim 1, wherein the usage level-based rule set defines a rule set for text messages, the method further comprising applying the rule set for text messages to control usage of text messages via the mobile device.

13. The method of claim 1, wherein the usage level-based rule set defines a rule set for data transfers, the method further comprising applying the rule set for data transfers to control usage of data transfers via the mobile device.

14. The method of claim 1, wherein the usage level-based rule set defines a rule set for billed content, the method further comprising applying the rule set for billed content to control access to billed content via the mobile device.

15. The method of claim 1, further comprising automatically populating at least a portion of the usage level-based rule set parameters based on a user's mobile service plan.

16. A machine-readable medium having a plurality of instructions stored thereon and configured to be executed on a mobile device to effect control of usage of the mobile device by performing operations comprising:
determining a current service plan mode in conjunction with initiating a call connection corresponding to an attempt to place an outgoing call or receipt of an incoming call page;
determining a current usage level corresponding to the service plan mode;
retrieving data relating to a usage level-based rule set defined by a supervisor user defining rules for controlling usage of the mobile device; and
applying an applicable rule from the usage level-based rule set based on a current usage level and the current service plan mode to allow or disallow establishment of the call connection.

17. The machine-readable medium of claim 16, wherein execution of the instructions performs further operations comprising enabling a supervisor user to enter parameters from which the usage level-based rule set is derived via the mobile device.

18. The machine-readable medium of claim 16, wherein execution of the instructions performs further operations comprising:
enabling data corresponding to the usage level-based rule set to be downloaded to the mobile device; and
storing the usage level-based rule set in a persistent manner on the mobile device.

19. The machine-readable medium of claim 16, wherein execution of the instructions performs further operations comprising:
tracking cumulative service usage on the mobile device for a given billing cycle; and
employing the cumulative service usage to determine an applicable rule to be applied for a corresponding service access event.

20. The machine-readable medium of claim 16, wherein the usage level-based rule set defines usage rules for at least two different usage levels for the same service parameter, and wherein execution of the plurality of instructions performs further operations comprising:
determining a current usage level for the service parameter; and
applying an access rule based on the highest usage level defined for the service parameter the current usage level meets or exceeds.

21. The machine-readable medium of claim 16, wherein the usage level-based rule set allows the supervisor user to restrict access to selected outgoing call recipients after an airtime usage level for a given billing cycle has been reached, and wherein execution of the instructions performs further operations comprising:
identifying an intended recipient of an attempted outgoing call;
determining a current airtime usage level for the billing cycle; and
applying an applicable rule from the usage level-based rule set to determine whether to allow or deny the outgoing call to be connected based on the intended recipient and the current airtime usage.

22. The machine-readable medium of claim 16, wherein the usage level-based rule set allows the supervisor user to restrict access to receive calls from selected incoming call recipients after an airtime usage level for a given billing cycle has been reached, and wherein execution of the instructions performs further operations comprising:
identifying a sender of incoming call;
determining a current airtime usage level for the billing cycle; and
applying an applicable rule from the usage level-based rule set to determine whether to allow or deny the incoming call to be connected based on the sender and the current airtime usage.

23. The machine-readable medium of claim 16, wherein at least a portion of the plurality of instructions comprises an application program configured to be run on a target operating system installed on the mobile device.

24. The machine-readable medium of claim 23, wherein a portion of the plurality of instructions comprises an agent that is configured to detect mobile device usage trigger events and facilitate communication of such events to the application program.

25. The machine-readable medium of claim 23, wherein the target operating system comprises a Symbian-based operating system.
